(19) United States
(12) Patent Application Publication
(10) Pub. No.: US 2026/0304220 A1
(43) Pub. Date: Oct. 1, 2026

(54) TIMELY RLC STATUS REPORT

(71) Applicant: QUALCOMM Incorporated, San Diego, CA (US)

(72) Inventor: Linhai HE, San Diego, CA (US)

(21) Appl. No.: 19/572,723

(22) Filed: Mar. 19, 2026

Related U.S. Application Data
(60) Provisional application No. 63/779,137, filed on Mar. 27, 2025.

(51) Int. Cl. H04W 28/04; H04L 1/1607; H04L 5/00

(52) U.S. Cl. CPC H04W 28/04; H04L 1/1642; H04L 5/0053

(57) ABSTRACT

Aspects relate to mechanisms for sending timely status reports for radio link control (RLC) protocol data units (PDUs). A receiving node can initiate a timer in response to identifying a gap in RLC sequence numbers of received RLC PDUs, indicating that one or more RLC PDUs are missing, and send a time-critical status report (TC-SR) to a transmitting node based on a value of the timer. The transmitting node can trigger the TC-SR by initiating a time-critical (TC) timer in response to transmission of a low-latency RLC PDU and sending a time critical (TC) poll for the TC-SR upon expiration of the TC timer.

### CROSS-REFERENCE TO RELATED APPLICATIONS

The present Application for Patent claims priority to and the benefit of pending U.S. Provisional Application No. 63/779,137, filed Mar. 27, 2025, and assigned to the assignee hereof and hereby expressly incorporated by reference herein as if fully set forth below in its entirety and for all applicable purposes.

### TECHNICAL FIELD

The technology discussed below relates generally to wireless communication systems, and more particularly, to radio link control (RLC) status reports.

### INTRODUCTION

In wireless communication systems, such as those specified under standards for 5G New Radio (NR), a user equipment (UE) may be capable of communicating with a network entity within a radio access network. The radio protocol architecture for a radio access network may include various layers, including, for example, a radio link control (RLC) sublayer and a medium access control (MAC) sublayer. The RLC sublayer provides various services, such as segmentation and reassembly of upper layer data packets, duplicate packet detection, and retransmission of lost data packets using an automatic repeat request (ARQ) mechanism. The MAC sublayer provides multiplexing between logical and transport channels and for retransmission of lost data packets at the physical layer using a hybrid automatic repeat request (HARQ) mechanism.

Unlike the RLC layer, which discards any protocol data units (PDUs) received in error, the MAC sublayer uses subsequent retransmissions in the HARQ process, which occur at a faster rate than ARQ, to reconstruct the PDU. However, if the MAC sublayer fails to deliver a PDU by HARQ, the RLC sublayer initiates ARQ to attempt to recover the PDU. During the ARQ procedure, acknowledgement of RLC PDUs is included in RLC status reports, which may be sent periodically or in response to a status request poll from the transmitter.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus is provided. The apparatus includes one or more memories and one or more processors coupled to the one or more memories. The one or processors are configured to cause the apparatus to obtain a plurality of received radio link control (RLC) protocol data units (PDUs) within a sequence of RLC PDUs from a transmitting node, where each of the RLC PDUs in the sequence of RLC PDUs includes a respective sequence number, initiate a timer in response to identifying a gap between the respective sequence numbers of the plurality of received RLC PDUs, where the gap includes one or more missing RLC PDUs within the sequence of RLC PDUs, and provide a time-critical status report (TC-SR) including a negative acknowledgement of at least one of the one or more missing RLC PDUs within the sequence of RLC PDUs based on at least a value of the timer.

Another example provides a method operable at a receiving node. The method includes obtaining a plurality of received radio link control (RLC) protocol data units (PDUs) within a sequence of RLC PDUs from a transmitting node, where each of the RLC PDUs in the sequence of RLC PDUs includes a respective sequence number, initiating a timer in response to identifying a gap between the respective sequence numbers of the plurality of received RLC PDUs, where the gap includes one or more missing RLC PDUs within the sequence of RLC PDUs, and providing a time-critical status report (TC-SR) including a negative acknowledgement of at least one of the one or more missing RLC PDUs within the sequence of RLC PDUs based on at least a value of the timer.

Another example provides an apparatus including means for obtaining a plurality of received radio link control (RLC) protocol data units (PDUs) within a sequence of RLC PDUs from a transmitting node, where each of the RLC PDUs in the sequence of RLC PDUs includes a respective sequence number, means for initiating a timer in response to identifying a gap between the respective sequence numbers of the plurality of received RLC PDUs, where the gap includes one or more missing RLC PDUs within the sequence of RLC PDUs, and means for providing a time-critical status report (TC-SR) including a negative acknowledgement of at least one of the one or more missing RLC PDUs within the sequence of RLC PDUs based on at least a value of the timer.

Another example provides a non-transitory computer-readable medium having stored therein instructions executable by one or more processors of an apparatus to cause the apparatus to obtain a plurality of received radio link control (RLC) protocol data units (PDUs) within a sequence of RLC PDUs from a transmitting node, where each of the RLC PDUs in the sequence of RLC PDUs includes a respective sequence number, initiate a timer in response to identifying a gap between the respective sequence numbers of the plurality of received RLC PDUs, where the gap includes one or more missing RLC PDUs within the sequence of RLC PDUs, and provide a time-critical status report (TC-SR) including a negative acknowledgement of at least one of the one or more missing RLC PDUs within the sequence of RLC PDUs based on at least a value of the timer.

Another example provides an apparatus including one or more memories and one or more processors coupled to the one or more memories. The one or processors are configured to cause the apparatus to provide a radio link control (RLC) protocol data unit (PDU), initiate a time-critical (TC) timer in response to transmission of the RLC PDU, provide a TC poll in response to expiration of the TC timer, and obtain a TC status report (TC-SR) including acknowledgement information associated with the RLC PDU based on the TC poll.

Another example provides a method operable at a transmitting node. The method includes providing a radio link control (RLC) protocol data unit (PDU), initiating a time-critical (TC) timer in response to transmission of the RLC PDU, providing a TC poll in response to expiration of the TC timer, and obtaining a TC status report (TC-SR) including acknowledgement information associated with the RLC PDU based on the TC poll.

Another example provides an apparatus including means for providing a radio link control (RLC) protocol data unit (PDU), means for initiating a time-critical (TC) timer in response to transmission of the RLC PDU, means for providing a TC poll in response to expiration of the TC timer, and means for obtaining a TC status report (TC-SR) including acknowledgement information associated with the RLC PDU based on the TC poll.

Another example provides a non-transitory computer-readable medium having stored therein instructions executable by one or more processors of an apparatus to cause the apparatus to provide a radio link control (RLC) protocol data unit (PDU), initiate a time-critical (TC) timer in response to transmission of the RLC PDU, provide a TC poll in response to expiration of the TC timer, and obtain a TC status report (TC-SR) including acknowledgement information associated with the RLC PDU based on the TC poll.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram providing a high-level illustration of one example of a configuration of a disaggregated base station according to some aspects.

FIGS. 3A, 3B, 3C, and 3D are diagrams illustrating examples of a first 5G/NR frame, DL channels within a 5G/NR subframe, a second 5G/NR frame, and UL channels within a 5G/NR subframe, respectively.

FIG. 4 is a diagram illustrating an example of a radio protocol architecture for the user plane and control plane according to some aspects.

FIG. 5 is a diagram illustrating an example of a structure of a Packet Data Convergence Protocol (PDCP) sublayer, a radio link control (RLC) sublayer, and a medium access control (MAC) sublayer according to some aspects.

FIG. 6 is a diagram illustrating an example of an RLC Acknowledged Mode (AM) entity according to some aspects.

FIG. 7 is a diagram illustrating an example of a format of a RLC Protocol Data Unit (PDU) according to some aspects.

FIG. 8 is a diagram illustrating an example of missing RLC PDUs according to some aspects.

FIG. 9 is a diagram illustrating another example of an RLC-AM entity according to some aspects.

FIGS. 10A and 10B are diagrams illustrating other examples of an RLC-AM entity of a receiver (e.g., a receiving device or receiving node) according to some aspects.

FIG. 11 is a diagram illustrating prioritization of TC-SRs at the RLC and MAC sublayers of a receiver according to some aspects.

FIG. 12 is a signaling diagram illustrating an example of a reduced latency ARQ retransmission using a time-critical status report according to some aspects.

FIG. 13 is a diagram illustrating another example of an RLC-AM entity according to some aspects.

FIG. 14 is a signaling diagram illustrating another example of reduced latency ARQ retransmission using a time-critical status report according to some aspects.

FIG. 15 is a block diagram illustrating an example of a hardware implementation for an apparatus employing a processing system according to some aspects.

FIG. 16 is a flow chart illustrating an exemplary process for timely radio link control (RLC) status reports (SRs) according to some aspects.

FIG. 17 is a flow chart illustrating another exemplary process for timely RLC SRs according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

Control information and data may be sent between wireless nodes (e.g., between a UE and a network entity) within protocol data units (PDUs). PDUs may include, for example, Internet Protocol (IP) packets, Ethernet frames and other unstructured data packets. Lower layers in the radio protocol stack may segment or concatenate PDUs received from upper layers into lower layer PDUs for transmission over the air interface to a receiving node. For example, a radio link control (RLC) sublayer in the protocol stack may concatenate or segment PDUs received from a Packet Data Convergence Protocol (PDCP) sublayer and send the resulting RLC PDUs to a medium access control (MAC) sublayer. The MAC sublayer may implement a hybrid automatic repeat request (HARQ) feedback mechanism to ensure reliability delivery of MAC PDUs to the receiving node. If the MAC sublayer fails to deliver a PDU by HARQ, the RLC sublayer takes over and initiates an ARQ feedback mechanism to retransmit the RLC PDU and re-initiate the MAC HARQ process. After the RLC sublayer sends an RLC PDU, the RLC sublayer wait for a status report from the receiving node indicating whether the RLC PDU was successfully received. If the status report includes a negative acknowledgement (NACK) indicating the RLC PDU was not successfully received, the RLC sublayer can retransmit the RLC PDU. In some cases, the transmitting node may send a poll request to the receiving node to trigger transmission of a status report from the receiving node. The ARQ/HARQ retransmission procedure is repeated until either the RLC PDU is correctly received or a configured maximum number of ARQ retransmissions is reached.

With the evolution of low-latency, such as extended reality (XR), the network generally schedules only a limited number of HARQ retransmissions at the MAC sublayer. This can be a more use of resources efficient if HARQ failure occurs infrequently. However, since HARQ failures create extra delay due to the additional RLC ARQ retransmission(s) and each RLC ARQ retransmission takes longer than a HARQ process due to the uplink access and two HARQ transmissions (round trip on both the downlink and uplink), this causes extra that is unfriendly to XR traffic, which is delay sensitive. Therefore, to make the RLC ARQ process useful for XR traffic, the round trip time of the RLC ARQ procedure should be reduced.

Various aspects are directed to mechanisms for reducing the round trip time of RLC ARQ retransmissions by sending timely status reports for missing RLC PDUs to reduce the latency. In some examples, the receiving node can initiate a timer (e.g., a time-critical status report (TC-SR) timer or other timer) in response to identifying a gap in RLC sequence numbers of received RLC PDUs, indicating that one or more RLC PDUs are missing, and send a time-critical status report (TC-SR) to the transmitting node upon expiration of the timer or in response to the timer falling below a threshold. The TC-SR can include a NACK for at least one of the one or more missing RLC PDUs. The transmitting node can then send a retransmission of at least one of the one or more missing RLC PDUs to the receiving node.

In other examples, the transmitting node can initiate a time-critical (TC) timer upon transmitting a low-latency RLC PDU and send a TC poll requesting a status report on the low-latency RLC PDU to the receiving node upon expiration of the TC timer. The receiving node can then send a TC-SR to the transmitting node including acknowledgement information (e.g., ACK or NACK) associated with the RLC PDU based on the TC poll.

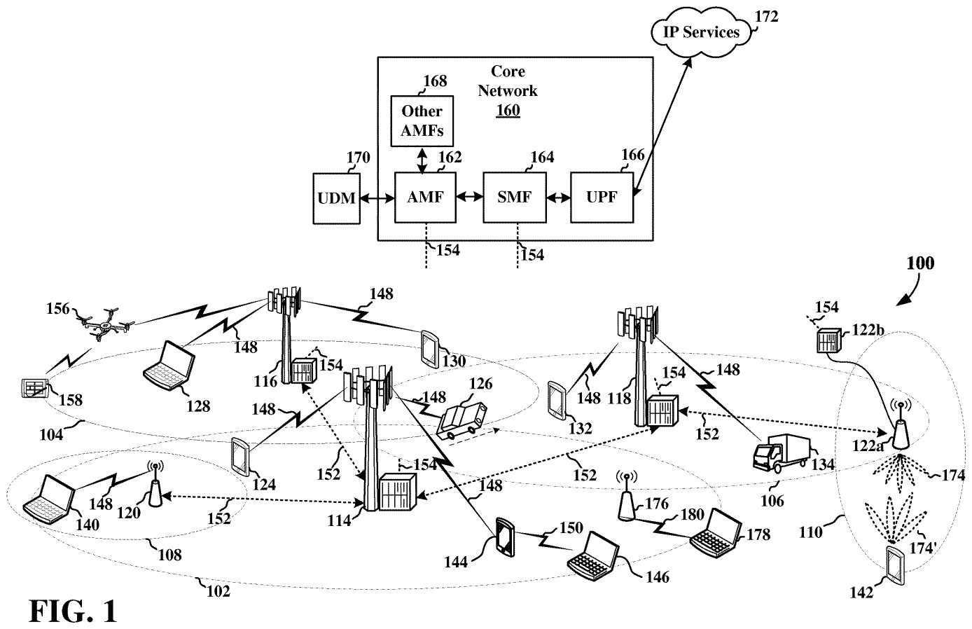

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz 7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

Deployment of communication systems, such as 5G new radio (NR) systems or 6G wireless systems, may be arranged in multiple manners with various components or constituent parts. In a 5G NR system or 6G system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN), also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

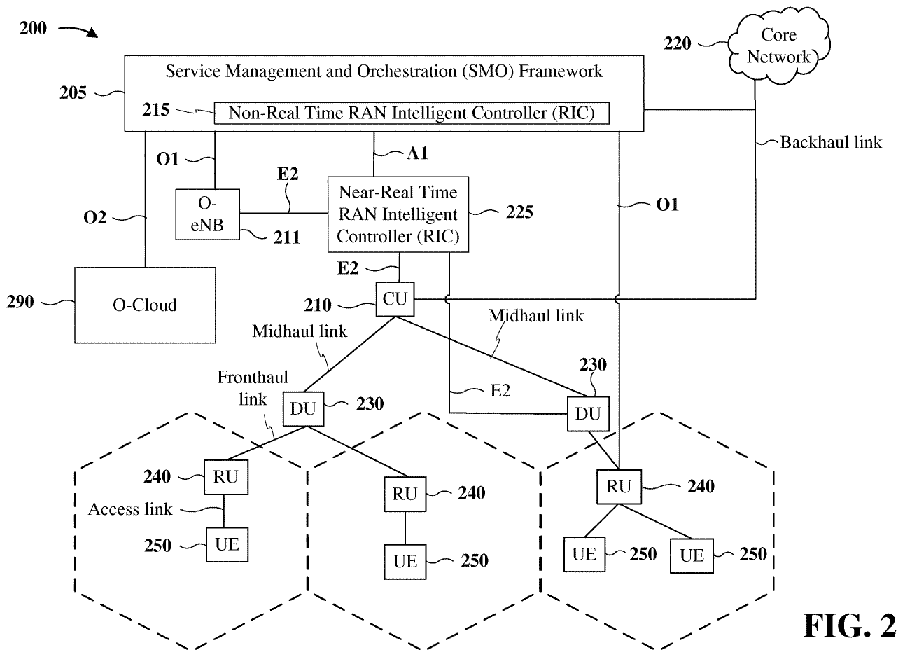

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 2rd Generation Partnership Project (2GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

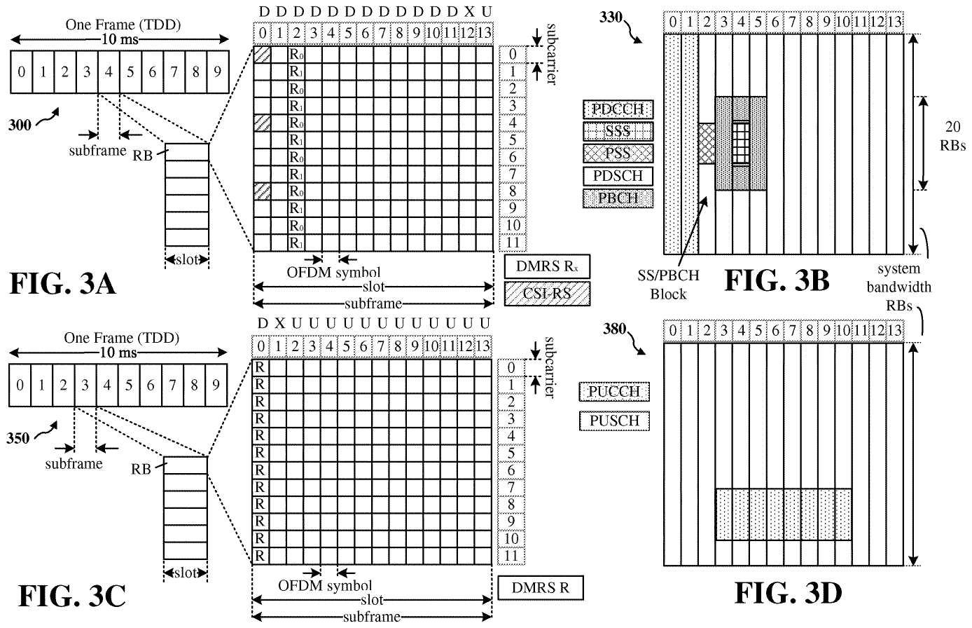

FIG. 3A is a diagram 300 illustrating an example of a first subframe within a 5G/NR frame structure. FIG. 3B is a diagram 330 illustrating an example of DL channels within a 5G/NR subframe. FIG. 3C is a diagram 350 illustrating an example of a second subframe within a 5G/NR frame structure. FIG. 3D is a diagram 380 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 3A, 3C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

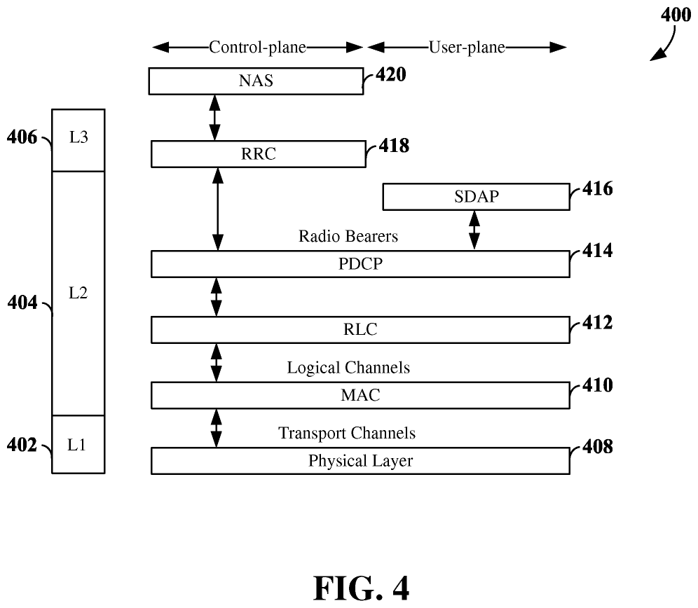

FIG. 4 is a diagram illustrating an example of a radio protocol architecture for the user plane and control plane according to some aspects. As illustrated in FIG. 4, the radio protocol architecture 400 for each of the UE and the network entity includes three layers: layer 1 (L1) 402, layer 2 (L2) 404, and layer 3 (L3) 406. L1 is the lowest layer and implements various physical layer signal processing functions. L1 will be referred to herein as the physical layer 408. L2 404 is above the physical layer 408 and is responsible for the link between the UE and network entity over the physical layer 408.

In the user plane, the L2 layer 404 includes a media access control (MAC) sublayer 410, a radio link control (RLC) sublayer 412, a packet data convergence protocol (PDCP) 414 sublayer, and a service data adaptation protocol (SDAP) sublayer 416, which are terminated at the network entity on the network side. Although not shown, the UE may have several upper layers above the L2 layer 404 including at least one network layer (e.g., IP layer and user data protocol (UDP) layer) that is terminated at the User Plane Function (UPF) on the network side and one or more application layers.

The SDAP sublayer 416 provides a mapping between a 5G core (5GC) quality of service (QoS) flow and a data radio bearer and performs QoS flow ID marking in both downlink and uplink packets. The PDCP sublayer 414 provides packet sequence numbering, in-sequence or out-of-sequence delivery of packets, retransmission of PDCP protocol data units (PDUs), re-ordering of received PDCP PDUs, and transfer of upper layer data packets to lower layers. PDU's may include, for example, Internet Protocol (IP) packets, Ethernet frames and other unstructured data (i.e., Machine-Type Communication (MTC), hereinafter collectively referred to as “packets”). The PDCP sublayer 414 also provides header compression for upper layer data packets to reduce radio transmission overhead, security by ciphering/deciphering the data packets, and integrity protection of data packets. A PDCP context may indicate whether PDCP duplication is utilized for a unicast connection.

The RLC sublayer 412 provides segmentation and reassembly of upper layer data packets, error correction through automatic repeat request (ARQ), duplicate packet detection, and sequence numbering independent of the PDCP sequence numbering. An RLC context or entity may indicate whether an acknowledged mode (e.g., a reordering timer is used) or an unacknowledged mode is used for the RLC sublayer 412. The MAC sublayer 410 provides multiplexing between logical and transport channels. The MAC sublayer 410 is also responsible for allocating the various radio resources (e.g., resource blocks) in one cell among the UEs and for HARQ operations. A MAC context or entity may enable, for example, a HARQ feedback scheme, resource selection algorithms, carrier aggregation, beam failure recovery, or other MAC parameters for a unicast connection. The physical layer 408 is responsible for transmitting and receiving data on physical channels (e.g., within slots). A PHY context may indicate a transmission format and a radio resource configuration (e.g., bandwidth part (BWP), numerology, etc.) for a unicast connection.

In the control plane, the radio protocol architecture for the UE and network entity is substantially the same for L1 402 and L2 404 with the exception that there is no SDAP sublayer in the control plane and there is no header compression function for the control plane. The control plane also includes a radio resource control (RRC) sublayer 418 in L4 and a higher Non-Access Stratum (NAS) layer 420. The RRC sublayer 418 is responsible for establishing and configuring signaling radio bearers (SRBs) and data radio bearers (DRBs) between the network entity and the UE, paging initiated by the 5GC or NG-RAN, and broadcast of system information related to Access Stratum (AS) and Non-Access Stratum (NAS). An SRB is a logical communication channel on Layer 2 (L2) of the radio protocol stack and higher layers for the transfer of control information between the UE and the NG-RAN. A DRB is a logical communication channel on L2 and higher layers for the transfer of data for a PDU session between the UE and the NG-RAN. The RRC sublayer 418 is further responsible for QoS management, mobility management (e.g., handover, cell selection, inter-RAT mobility), UE measurement and reporting, and security functions. The NAS layer 420 is terminated at the AMF in the core network and performs various functions, such as authentication, registration management, and connection management.

In general, packets received by a sublayer from an upper sublayer may be referred to as Service Data Units (SDUs), while packets output from a sublayer to a lower sublayer may be referred to as Protocol Data Units (PDUs). For example, packets received by the RLC sublayer 412 from an upper sublayer may be referred to as RLC SDUs, and packets output from the RLC sublayer 412 to the MAC sublayer 410 may be referred to as RLC PDUs or MAC SDUs. As used herein, the terms RLC PDU and MAC SDU may be used interchangeably.

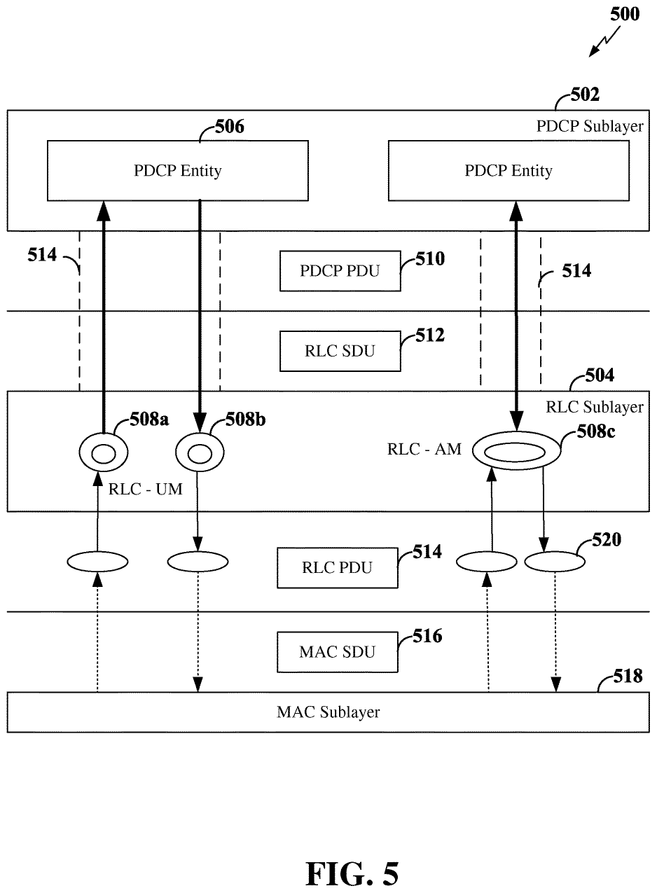

FIG. 5 is a diagram illustrating an example of a structure 500 of a Packet Data Convergence Protocol (PDCP) sublayer 502, radio link control (RLC) sublayer 504, and a medium access control (MAC) sublayer 518 according to some aspects. The PDCP sublayer 502 includes one or more PDCP entities 506 defined for a device (e.g., a UE). In addition, the RLC sublayer 504 includes one or more RLC entities 508 defined for the UE. Each PDCP entity 506 carries data for one radio bearer 514 (e.g., data radio bearer (DRB), sidelink radio bearer (SRB), or signaling radio bearer (SRB)). A PDCP entity 506 is, therefore, associated to either the control plane or the user plane depending on the radio bearer 514 for which it is carrying data.

Each PDCP entity 506 is associated with one, two, or four (e.g., uni-directional/bi-directional or split/non-split) RLC entities 508a-508c depending on the radio bearer characteristics (e.g., uni-directional or bi-directional) or the RLC mode. Here, the RLC mode may be either the transparent mode (TM), unacknowledged mode (UM mode) or acknowledged mode (AM). The TM is used for SRB0, paging, and broadcast of system information. The UM may be used, for example, to transmit delay sensitive packets, such as VoIP packets. In the UM, the receiving device does not acknowledge reception of data packets to the transmitting device (e.g., the receiving device does not transmit ACK/NACK to the transmitting device). The AM supports an ARQ mechanism to retransmit lost PDUs.

For split bearers (e.g., in dual-connectivity (DC) mode) or for radio bearers configured with PDCP duplication, each PDCP entity is associated with two bi-directional AM RLC entities. For LTE-WLAN (LWA) bearers, each PDCP entity 506 is associated with one (bi-directional) AM RLC entity or two (uni-directional) UM RLC entities. For dual active protocol stack (DAPS) bearers, each PDCP entity is associated with two UM RLC entities (for same direction, one for source and one for target cell), four uni-directional UM RLC entities (two for each direction on source cell and target cell), or two bi-directional AM RLC entities (one for source cell and one for target cell). Otherwise, each PDCP entity is associated with one bi-directional UM RLC entity, two uni-directional UM RLC entities, or one bi-directional AM RLC entity. In the example shown in FIG. 5, one of the PDCP entities 506 is associated with two uni-directional UM RLC entities 508a/508b, while the other PDCP entity 506 is associated with a bi-directional AM RLC entity 508c.

The PDCP entities 506 and corresponding RLC entities 508 exchange PDCP PDUs 510, which may also be referred to as RLC SDUs 512. For example, an RLC entity 508 may receive a PDCP PDU 510/RLC SDU 512 from a corresponding PDCP entity 506. Similarly, the RLC entities 508 exchange RLC PDUs 514, which may also be referred to as MAC SDUs 516, with the MAC sublayer 518. Each RLC entity 508 may communicate RLC PDUs via logical channels 520 to the MAC sublayer 518, which maps between logical channels and transport channels between the MAC sublayer 518 and the physical layer (not shown). For example, the MAC sublayer 518 can multiplex MAC SDUs 516 from one or more logical channels 520 onto transport blocks to be delivered to the physical layer on transport channels. Similarly, the MAC sublayer 518 can demultiplex MAC SDUs for one or more logical channels from transport blocks delivered from the physical layer on transport channels.

One of the functions provided by the MAC sublayer 518 is error correction through a hybrid automatic repeat request (HARQ) mechanism in order to successfully deliver MAC PDUs to a receiving device (e.g., a receiver). HARQ uses feedback provided from the receiver to the transmitter to indicate whether a particular PDU/transport block has been correctly received. For example, the receiver can send an acknowledgement (ACK) for each correctly decoded transport block and a negative acknowledgement (NACK) for each incorrectly decoded transport block. The MAC sublayer 518 may implement Type I HARQ, which adds both error detection and forward error correction (FEC) bits to each PDU, or Type II HARQ, which alternates between error detecting bits and FEC/error detection bits. With Type II HARQ, the first transmission may contain only data and error detection bits, and if the first transmission is received in error, the second transmission can contain both FEC bits and error detection bits. The receiver can then perform error correction by combining the information received in both transmissions. For either Type I or Type II HARQ, incorrectly decoded data blocks can be stored at the receiver and when a retransmitted data block is received, the two blocks can be combined using, for example, Chase combining or incremental redundance (IR).

One of the functions provided by RLC-AM entities 508c at the RLC sublayer 504 is error control through an automatic repeat request (ARQ) mechanism that uses acknowledgement information (ACK/NACK) to determine whether an RLC PDU is received correctly at the receiver. At the RLC sublayer 504, acknowledgement information is sent in a status report (SR) that is sent periodically from the receiver to the transmitter or in response to a poll request from the transmitter. A transmitter may send a poll request, for example, if the number of transmitted RLC PDUs exceeds a threshold or the amount of transmitted RLC data (e.g., in bytes) exceeds a threshold. If an RLC-AM entity 508c does not receive an ACK for an RLC PDU 514 (e.g., receives a NACK or no response), the RLC entity 508c sends the exact same RLC PDU again. Typically, if the MAC sublayer 518 fails to deliver an RLC PDU 514 via HARQ, the RLC sublayer 504 initiates the ARQ process to retransmit the exact same RLC PDU again (which restarts the HARQ process in the MAC sublayer 518). This process is repeated until an RLC PDU 514 is successfully received or a configured maximum number of retransmissions is reached (in which case the transmitter considers the RLC PDU lost and aborts transmission of the RLC PDU).

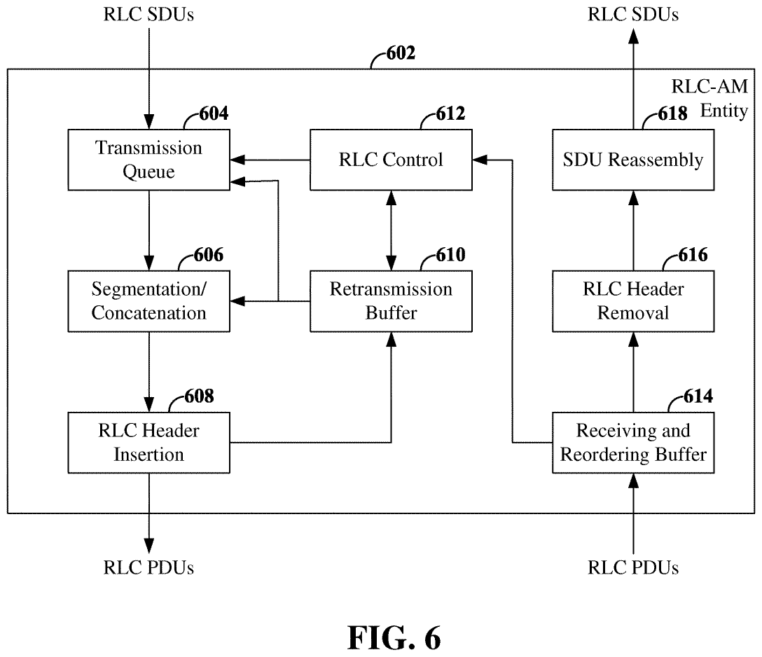

FIG. 6 is a diagram illustrating an example of an RLC-AM entity according to some aspects. The RLC-AM entity 600 includes a transmission queue 604 (transmission buffer), segmentation/concatenation circuitry 606, RLC header insertion circuitry 608, retransmission buffer 610, and RLC control circuitry 612 on the transmitting side. The RLC-AM entity 600 further includes a receiving and reordering buffer 614, RLC header removal circuitry 616, and SDU reassembly circuitry 618 on the receiving side. For an RLC PDU transmission, higher layer RLC SDUs (e.g., from the PDCP sublayer or RRC) are received into the transmission queue 604. The segmentation/concatenation circuitry 606 segments or concatenates the RLC SDUs into RLC PDUs that have a predefined size based on the MAC transport block size (TBS). For example, small RLC SDUs can be concatenated into a single RLC PDU, whereas a larger RLC SDU may be segmented into multiple RLC PDUs. The RLC header insertion circuitry 608 then inserts an RLC header, including an RLC sequence number of the RLC PDU, into the RLC PDU and makes a copy of the RLC PDU for storage in the retransmission buffer 610 for possible retransmission of the RLC PDU. The RLC PDU may then be output to the next layer (e.g., MAC sublayer).

If the RLC-AM entity 600 receives a NACK in a SR or does not receive a SR for a predefined period of time for the RLC PDU, the RLC control circuitry 612 can retrieve the copy of the RLC PDU maintained in the retransmission buffer 610 and retransmit the RLC PDU. However, if the RLC-AM entity 600 receives an ACK in a SR for the RLC PDU, the RLC control circuitry 612 can discard the copy of the RLC PDU in the retransmission buffer 610.

On the receiving side, incoming RLC PDUs (MAC SDUs) from the MAC sublayer are received into the receiving and reordering buffer 614, where the RLC PDUs are reordered based on their respective sequence numbers. In addition, the RLC control circuitry 612 generates an ACK for each correctly received RLC PDU and includes the ACK in a SR sent periodically or in response to receiving a poll request. For example, one of the received RLC PDUs may include a poll bit requesting an ACK/NACK for the RLC PDU. The SR may be generated, for example, by the RLC control circuitry 612 and provided to the transmission queue 604 for transmission to the receiver. If there is a gap in sequence number of the received RLC PDUs, indicating that one or more RLC PDUs are missing, the RLC control circuitry 612 can initiate a reordering timer. Upon expiration of the reordering timer, the RLC control circuitry 612 can consider the missing RLC PDUs lost and generate a NACK for inclusion in a SR sent periodically or in response to a poll request.

The RLC header removal circuitry 616 then removes the respective RLC headers from the received RLC PDUs. In addition, the SDU reassembly circuitry 618 assembles the RLC PDUs into upper layer SDUs (e.g., RLC SDUs/PDCP PDUs) for output to the upper layer (e.g., PDCP sublayer).

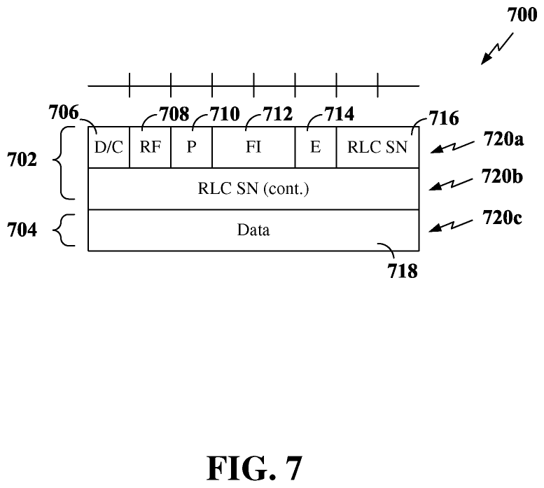

An example of an RLC Acknowledged Mode Data (AMD) PDU format is illustrated in FIG. 7. The acknowledged mode supports an ARQ mechanism to retransmit lost PDUs. In the example shown in FIG. 7, the RLC AMD PDU format 700 includes a header 702 and a body 704. The header 702 occupies the first two octets 720a and 720b and includes a D/C field 706, a re-segmentation flag (RF) field 708, a polling bit (P) field 710, a Framing Information (FI) field 712, an Extension bit (E) field 714 and SN field 716. The D/C field 706 indicates whether the RLC PDU contains user plane data or control plane data. The RF field 708 indicates whether the RLC PDU is an AMD PDU or an AMD PDU segment. The P field 710 indicates whether the transmitting device is requesting the status of previously transmitted RLC PDUs from the receiving device. The P field 710 may correspond, for example, to a polling bit requesting a status report (SR) from the receiving device.

The FI field 712 indicates whether the RLC PDU is segmented at the beginning and/or end of the data field. The E field 714 indicates whether a data field or a set of E field and Length Indicator (LI) fields follow the SN field 716. The SN field 716 occupies the remainder of the first octet 720a and the entirety of the second octet 720b. The SN field 716 contains the sequence number (SN) of the RLC PDU. In some examples, the SN may contain 10 bits. The body 704 contains uncompressed or compressed user or control plane data 718 and may include one or more octets (only one octet 720c of which is shown for simplicity).

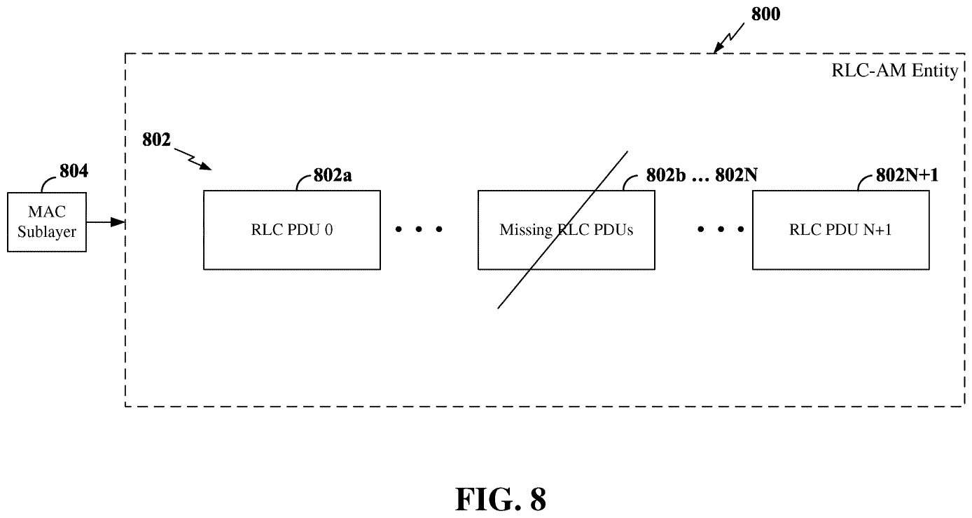

FIG. 8 is a diagram illustrating an example of missing RLC PDUs according to some aspects. An RLC-AM entity 800 can receive RLC PDUs 802 from the MAC sublayer 804 with or without holes (e.g., missing one or more RLC PDUs within a sequence of RLC PDUs 802). For example, RLC holes may arise when there is a missing RLC PDU. If the RLC-AM entity 800 receives a plurality of RLC PDUs 802 from the MAC sublayer 804 without holes (e.g., without one or more missing RLC PDUs), the RLC-AM entity 800 can deliver the corresponding RLC SDUs to the upper layer. However, if the RLC-AM entity 800 receives a plurality of RLC PDUs 802a . . . 802N+1 with at least one missing RLC PDU (e.g., RLC PDUs 802b . . . 802N), the RLC-AM entity 800 may be configured to implement a reordering timer and hold the received RLC PDU 802N+1 with at least one missing RLC PDU 802b . . . 802N before it until the missing RLC PDU(s) 802b . . . 802N+1 are received or the reordering timer expires. For example, upon expiration of the reordering timer, the RLC-AM entity 800 can ignore missing RLC PDUs 802b . . . 802N and deliver the RLC SDUs corresponding to the received RLC PDUs 802N+1 during the reordering timer duration to the upper layer.

During the reordering timer, the RLC-AM entity 800 can send a NACK in a status report (e.g., either periodically or in response to a poll request) to the transmitter to initiate an ARQ retransmission. However, the RLC-AM entity 800 can further include a status report prohibit timer in order to prohibit transmission of a status report within the pendency of the status report prohibit timer, thereby reducing overhead (e.g., reducing the number of status requests sent from the receiver to the transmitter). For example, the RLC-AM entity 800 can initiate the status report prohibit timer upon sending a status report to prevent the RLC-AM entity 800 from sending another status report prior to expiration of the status report prohibit timer. Any poll requests received during pendency of the status report prohibit timer are queued until the expiration of the status report prohibit timer.

With the evolution of low-latency applications (e.g., cloud gaming, extended reality (XR), augmented reality (AR), virtual reality (VR), etc), the network generally schedules only a limited number of HARQ retransmissions at the MAC sublayer. This can be more resource efficient if HARQ failure (e.g., reaching the maximum number of HARQ retransmissions) occurs with only a low probability. However, HARQ failures create extra delay since each HARQ failure initiates an RLC ARQ retransmission (up to the maximum number of ARQ retransmissions) and each RLC ARQ retransmission takes longer than a HARQ process due to the uplink access and two HARQ transmissions (round trip on both the downlink and uplink). This additional delay is undesirable by XR/VR traffic due to the low-latency requirements of an XR/VR application.

Therefore, various aspects are directed to mechanisms for reducing the round trip time of RLC ARQ retransmissions. In some examples, the receiver can send a status report for a missing RLC PDU with reduced latency. However, to reduce overhead, the receiver can avoid sending a status report immediately upon discovering a missing RLC PDU. Instead, the receiver may send the status report based on the delay budget of the missing RLC PDU. In some examples, the receiver can initiate a timer (e.g., a time-critical status report (TC-SR) timer or other timer) in response to identifying a gap in RLC sequence numbers of received RLC PDUs and send a time-critical status report (TC-SR) to the transmitter upon expiration of the timer or in response to the timer falling below a threshold. In other examples, the transmitter can initiate a time-critical (TC) timer upon transmitting a low-latency RLC PDU (e.g., an XR/VR RLC PDU) and send a TC poll requesting a status report on the low-latency RLC PDU to the receiver upon expiration of the TC timer.

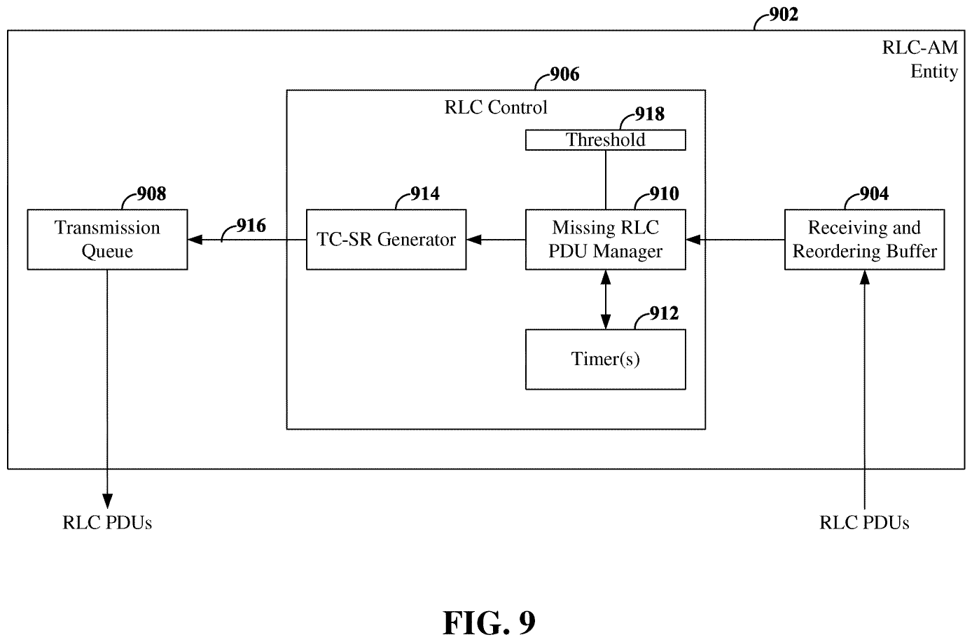

FIG. 9 is a diagram illustrating another example of an RLC-AM entity according to some aspects. In some examples, the RLC-AM entity 900 can correspond to the RLC-AM entity 600 shown in FIG. 6. In the example shown in FIG. 9, the RLC-AM entity 900 includes a receiving and reordering buffer 904, RLC control circuitry 906, and a transmission queue 908 (transmission buffer). The RLC control circuitry 906 can include a missing RLC PDU manager 910, one or more timers 912, and a time-critical status report (TC-SR) generator 914.

Incoming RLC PDUs (MAC SDUs) from the MAC sublayer are received into the receiving and reordering buffer 904, where the RLC PDUs are reordered based on their respective sequence numbers. In some examples, the incoming RLC PDUs are part of a sequence of RLC PDUs for low latency traffic. If there is a gap in sequence number of the received RLC PDUs, indicating that one or more RLC PDUs are missing, the missing RLC PDU manager 910 in the RLC control circuitry 906 can initiate a timer 912. The duration of the timer 912 may be configured by the network or set in accordance with one or more standards or specifications.

In some examples, the timer 912 is a TC-SR timer that is initialized in response to identifying a gap between the respective sequence numbers of a plurality of received RLC PDUs at the receiving and reordering buffer 904. Upon expiration of the TC-SR timer, the missing RLC PDU manager 910 instructs the TC-SR generator 914 to generate a time-critical status report (TC-SR) 916 and to provide the TC-SR to the transmission queue 908 for transmission to the transmitter within an RLC PDU. The TC-SR 916 includes a NACK for at least one of the one or more missing RLC PDUs.

In some examples, the timer 912 is an obsolete PDU detection timer that is also initialized in response to identifying a missing RLC PDU based on the gap in sequence numbers of received RLC PDUs. However, the obsolete PDU detection timer is configured with a time corresponding to a reduced delay budget for low-latency traffic, such as XR/VR, in order to avoid unnecessary retransmissions for low-latency traffic. Upon expiration of the obsolete PDU detection timer, the missing RLC PDU manager 910 considers the missing RLC PDU lost and discontinues retransmission of the missing RLC PDU. For example, the missing RLC PDU manager 910 can generate a normal status report (SR) that includes a fake ACK for the missing RLC PDU, so that the transmitter believes the missing RLC PDU has been successfully received and thus stops the retransmission of the missing RLC PDU. However, to improve the likelihood of successfully receiving the missing RLC PDU prior to expiration of the obsolete PDU detection timer, the missing RLC PDU manager 910 can compare a current value of the obsolete PDU detection timer to a threshold 918 (e.g., the missing RLC PDU manager 910 can compare each new value of the obsolete PDU detection timer to the threshold 918), and request the TC-SR generator 914 to generate a TC-SR 916 for the missing RLC PDU in response to the current value of the obsolete PDU detection timer falling below the threshold. The threshold 918 may be set to ensure sufficient time for one or more ARQ retransmissions of the missing RLC PDU prior to expiration of the obsolete PDU detection timer.

In some examples, the timer 912 (e.g., TC-SR timer or obsolete PDU detection timer) is per PDU, such that the number of timers equals the number of missing RLC PDUs. In other examples, the timer 912 is per RLC-AM entity, such that a single timer is initialized regardless of the number of missing RLC PDUs within the sequence number gap.

In some examples, the TC-SR 916 may further be exempt from the Status report prohibit timer (e.g., one of the timers 912) to enable the TC-SR 916 to be sent prior to expiration of the Status report prohibit timer. For example, the Status report prohibit timer may be initialized by the RLC control circuitry 906 in response to sending an immediately prior normal SR (e.g., which may include an ACK and/or NACK for one or more RLC PDUs) to reduce the overhead caused by sending frequent SRs. The missing RLC PDU manager 910 can instruct the TC-SR generator 914 to generate and send the TC-SR 916 during the Status report prohibit timer window (e.g., while the Status report prohibit timer is running). In some examples, the TC-SR 916 may be subject to a shorter Status report prohibit timer (e.g., one of the timers 912) initialized for low latency traffic and that has a shorter duration than a normal Status report prohibit timer. For example, the shorter (low latency) Status report prohibit timer may be initialized by the RLC control circuitry 906 in response to sending an immediately prior normal SR (e.g., which may include an ACK and/or NACK for one or more RLC PDUs) or an immediately prior TC-SR (e.g., which includes a NACK for one or more missing RLC PDUs). The missing RLC PDU manager 910 can instruct the TC-SR generator 914 to generate and send the TC-SR 916 upon expiration of the shorter Status report prohibit timer.

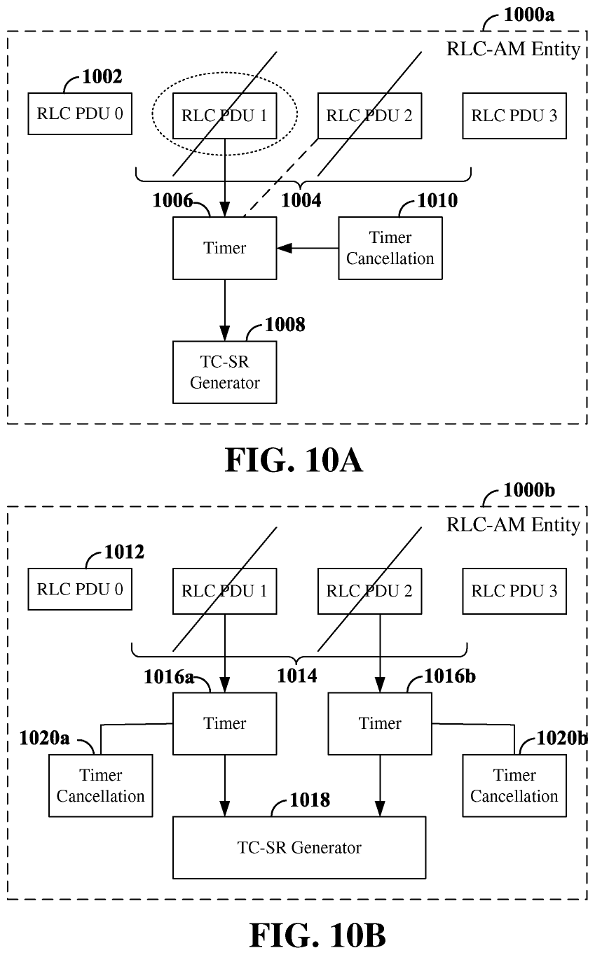

FIGS. 10A and 10B are diagrams illustrating other examples of an RLC-AM entity of a receiver (e.g., a receiving device or receiving node) according to some aspects. In the example shown in FIG. 10A, an RLC-AM entity 1000a is configured to receive a plurality of RLC PDUs 1002 (e.g., RLC PDU 0 and RLC PDU 3) within a sequence of RLC PDUs (e.g., RLC PDU 0, RLC PDU 1, RLC PDU 2, and RLC PDU 3). One or more of the RLC PDUs (e.g., RLC PDU 1 and RLC PDU 2) in the sequence of RLC PDUs is identified as missing based on a gap 1004 in sequence number between received RLC PDUs (e.g., between RLC PDU 0 and RLC PDU 3). The RLC-AM entity 1000a (e.g., the RLC control circuitry 906 and/or missing RLC PDU manager 910 shown in FIG. 9) initiates a single timer 1006 (e.g., a TC-SR timer or obsolete PDU detection timer) when the gap 1004 in sequence numbers is detected. The RLC-AM entity 1000a further includes a TC-SR generator 1008, as indicated in FIG. 9, that is configured to generate a TC-SR based on a value of the timer 1006. For example, the TC-SR generator 1008 may be configured to generate the TC-SR upon expiration of the timer 1006 or in response to the value of the timer dropping below a threshold.

In some examples, the timer 1006 may be associated, for example, with the missing RLC PDU having the lowest sequence number in the gap 1004. For example, the timer 1006 may be associated with missing RLC PDU 1. In some examples, the RLC-AM entity 1000a (e.g., the RLC control circuitry 906 shown in FIG. 9) may further include timer cancellation circuitry 1010 configured to cancel the timer 1006 in response to receiving the missing RLC PDU 1 prior to transmission of the TC-SR (e.g., prior to expiration of the TC-SR timer 1006 or prior to the obsolete PDU detection timer value falling below the threshold). Here, the term cancel refers to discontinuing or stopping the TC-SR timer 1006 or discontinuing comparing the timer value of the obsolete PDU detection timer 1006 to the threshold. In examples in which the gap 1004 includes more than one missing RLC PDU that still has not been received after cancellation of the TC-SR timer 1006, the RLC-AM entity 1000a (e.g., the RLC control circuitry 906 and/or missing RLC PDU manager 910 shown in FIG. 9) may be configured to increment the lowest sequence number in the gap 1004 by one to produce a new lowest sequence number of missing RLC PDUs in the gap 1004. For example, the missing RLC PDU with the lowest sequence number may now be RLC PDU 2. The RLC-AM entity 1000a (e.g., the RLC control circuitry 906 and/or missing RLC PDU manager 910 shown in FIG. 9) then re-initiates the timer 1006 for RLC PDU 2. This process continues for each continued missing RLC PDU in the gap 1004 until all missing RLC PDUs in the gap 1004 are received or the TC-SR is sent.

In the example shown in FIG. 10B, an RLC-AM entity 1000b is configured to receive a plurality of RLC PDUs 1012 (e.g., RLC PDU 0 and RLC PDU 3) within a sequence of RLC PDUs (e.g., RLC PDU 0, RLC PDU 1, RLC PDU 2, and RLC PDU 3). One or more of the RLC PDUs (e.g., RLC PDU 1 and RLC PDU 2) in the sequence of RLC PDUs is identified as missing based on a gap 1014 in sequence number between received RLC PDUs (e.g., between RLC PDU 0 and RLC PDU 3). The RLC-AM entity 1000b (e.g., the RLC control circuitry 906 and/or missing RLC PDU manager 910 shown in FIG. 9) initiates a respective timer 1016a and 1016b (e.g., a TC-SR timer or obsolete PDU detection timer) for each missing RLC PDU (e.g., RLC PDU 1 and RLC PDU 2). The RLC-AM entity 1000b further includes a TC-SR generator 1018, as indicated in FIG. 9, that is configured to generate a respective TC-SR for each missing RLC PDU based on a respective value of the timer 1016a and 1016b associated with the respective missing RLC PDU. For example, the TC-SR generator 1018 may be configured to generate a first TC-SR upon expiration of the timer 1016a or in response to the value of the timer 1016a dropping below a threshold. In addition, the TC-SR generator 1018 may be configured to generate a second TC-SR upon expiration of the timer 1016b or in response to the value of the timer 1016b dropping below a threshold.

In some examples, the RLC-AM entity 1000b (e.g., the RLC control circuitry 906 shown in FIG. 9) may further include respective timer cancellation circuitry 1020a and 1020b configured to cancel the respective timer 1016a and 1016b for each of the missing RLC PDUs (e.g., RLC PDU 1 and RLC PDU 2) that are received prior to transmission of the respective TC-SR (e.g., prior to expiration of the respective TC-SR timer 1016a and 1016b or prior to the respective obsolete PDU detection timer value falling below the threshold). Here, the term cancel refers to discontinuing or stopping the TC-SR timer 1016a/1016b or discontinuing comparing the timer value of the obsolete PDU detection timer 1016a/1016b to the threshold. For example, timer cancellation circuitry 1020a may discontinue the TC-SR timer 1016a or discontinue comparing the obsolete PDU detection timer 1016a to the corresponding threshold upon receiving RLC PDU 1 at which point the TC-SR (with a NACK) for RLC PDU 1 is not sent. In addition, timer cancellation circuitry 1020b may discontinue the TC-SR timer 1016b or discontinue comparing the obsolete PDU detection timer 1016b to the corresponding threshold upon receiving RLC PDU 2 at which point the TC-SR (with a NACK) for RLC PDU 2 is not sent.

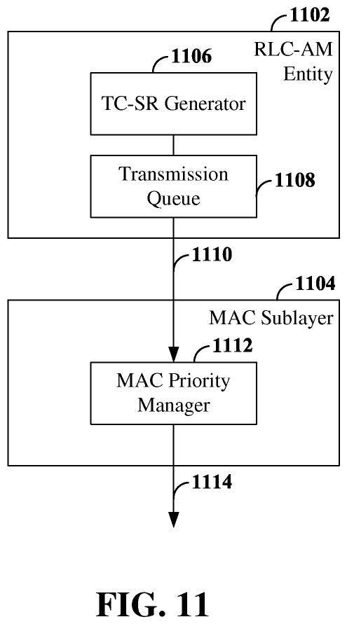

FIG. 11 is a diagram illustrating prioritization of TC-SRs at the RLC and MAC sublayers of a receiver according some aspects. In the RLC sublayer, an RLC-AM entity 1102 includes a TC-SR generator 1106 configured to generate a TC-SR 1110 (e.g., based on a value of a timer), as described above in connection with FIGS. 9, 10A, and 10B. The TC-SR generator 1106 provides the TC-SR 1110 to a transmission queue 1108 for transmission to a transmitter. In some examples, the TC-SR 1110 is placed at the head of the transmission queue 1108 to ensure that the TC-SR 1110 is sent before any other types of RLC control PDUs and RLC data PDUs.

In the MAC sublayer 1104, a MAC priority manager 1112 is configured to manage a priority of the TC-SR 1110 sent in a MAC PDU 1116. In some examples, the MAC priority manager 1112 is configured to send the TC-SR 1110 with a first priority higher than a second priority of a logical channel (e.g., 520 shown in FIG. 5) associated with the RLC entity 1102. For example, the MAC priority manager 1112 may set the priority of the TC-SR 1110 to a highest configurable priority for a data logical channel or to a network-configured priority for the TC-SR 1110. Here, the network-configured priority is applicable to all logical channels carrying TC-SRs. In some examples, the MAC priority manager 1112 may set the priority of the TC-SR 1110 to an additional priority defined for the logical channel that is higher than a normal default priority of the logical channel. For example, the second priority of the logical channel may be a default priority and the first priority may be a higher configured priority for the logical channel than the default priority.

The MAC priority manager 1112 may further be configured to manage a logical channel prioritization (LCP) leaky budget limit of the logical channel of the RLC entity 1102. For regular data, the data from a logical channel can be multiplexed into a PUSCH transmission only if the LCP leaky budget limit Bⱼ of the associated logical channel is greater than zero. When constructing a MAC PDU, the MAC sublayer 1104 decides the amount of data from each RLC logical channel to be included in the MAC PDU. Data is typically included within the MAC PDU in order of priority of logical channels for logical channels with Bⱼ>0, but the amount of data included in the MAC PDU is initially limited to the prioritized bit rate (PBR) of the logical channel. The PBR effectively places a limit on the amount of data from each logical channel that can be included in a MAC PDU to ensure logical channels with lower priorities are served. Once all logical channels have been served up to their PBR, if there is still room left in the MAC PDU, each logical channel is served again in order of priority based on their PBRs without regard for Bⱼ. The MAC priority manager 1112 decrements the limit Bⱼ of the associated logical channel by the total size of data served to the MAC PDU and then increases the limit Bⱼ of the associated logical channel by the PBR of that logical channel for each new MAC PDU.

In some examples, the MAC priority manager 1112 may be configured to ignore the value of Bⱼ for the logical channel associated with the TC-SR. As a result, the TC-SR 1110 may be included in the MAC PDU 1114 even if the limit Bⱼ is less than zero. Thus, the TC-SR 1110 may be sent in violation of a LCP leaky bucket limit of the logical channel of the RLC entity. As a result, the TC-SR 1110 can be prioritized to reduce receiver side latency in ARQ retransmissions.

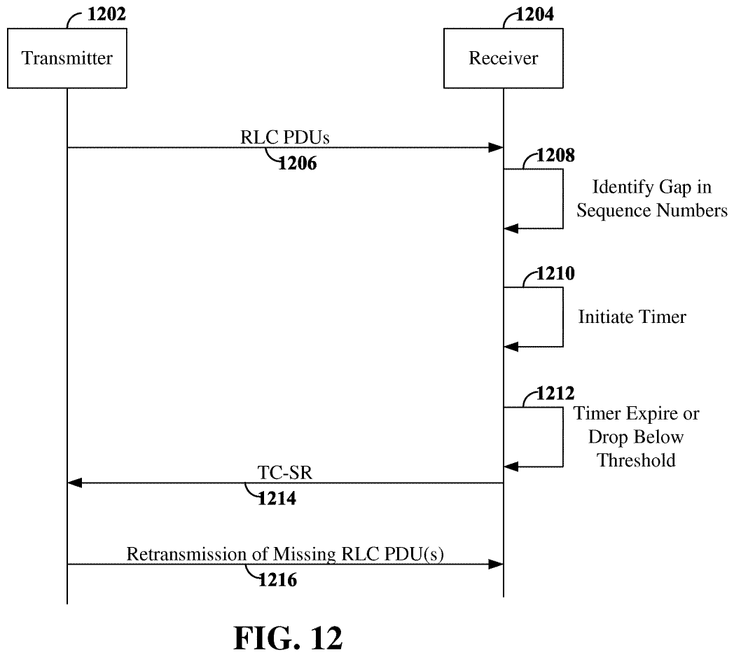

FIG. 12 is a signaling diagram illustrating an example of a reduced latency ARQ retransmission between a transmitter 1202 (e.g., transmitting node) and a receiver 1204 (e.g., receiving node) using a time-critical status report according to some aspects. Each of the transmitter 1202 and the receiver 1204 may correspond, for example, to one of a user equipment (UE) or a network entity. For example, the transmitter 1202 may be a network entity and the receiver 1204 may be a UE, or vice-versa. The UE may correspond to any of the UEs or other wireless communication devices shown in any of FIGS. 1 and/or 2. The network entity may correspond to any of the base stations or other network entities shown in FIGS. 1 and/or 2. For example, the network entity may correspond to an aggregated base station, an RU, a DU, a CU, a TRP, an IAB node, or other network device.

At 1206, the transmitter 1202 may transmit a sequence of RLC PDUs to the receiver 1204. Each RLC PDU in the sequence of RLC PDUs includes a sequence number, as shown in FIG. 7. In some examples, the RLC PDUs may carry low-latency traffic, such as XR/VR traffic. One or more of the RLC PDUs may not be received correctly at the receiver 1204. Therefore, at 1208, the receiver 1204 can identify a gap in sequence numbers of the correctly received RLC PDUs, indicating that there are one or more missing RLC PDUs in the sequence of RLC PDUs.

At 1210, the receiver 1204 may initiate a timer in response to identifying the gap in sequence numbers. In some examples, the timer is a TC-SR timer that triggers the transmission of a TC-SR to reduce ARQ retransmission latency. In other examples, the timer is an obsolete PDU detection timer that triggers the transmission of a normal SR including a fake ACK to avoid unnecessary retransmissions for low-latency traffic. In some examples, the receiver 1204 may initiate a single timer applicable to the missing RLC PDU with the lowest sequence number in the gap. In other examples, the receiver 1204 may initiate a respective timer for each missing RLC PDU in the gap.

At 1212, the receiver 1204 may determine that either the timer has expired or the timer has dropped below a threshold. For example, if the timer is a TC-SR timer, the receiver may determine that the TC-SR has expired. As another example, if the timer is an obsolete PDU detection timer, the receiver may determine that the obsolete PDU detection timer has dropped below the threshold.

At 1214, the receiver 1204 may generate and transmit a TC-SR to the transmitter 1202. The TC-SR includes a NACK for at least one of the missing RLC PDUs. For example, the TC-SR may include a respective NACK for each of the missing RLC PDUs or may include a NACK for a single missing RLC PDU (e.g., for the missing RLC PDU with the lowest sequence number). In some examples, the receiver 1204 may generate a respective TC-SR for each missing RLC PDU for which the respective timer expires or drops below the threshold. In this example, each TC-SR includes a NACK for a single missing RLC PDU associated with the respective timer. At 1216, the transmitter 1202 transmits an ARQ retransmission of one or more of the missing RLC PDUs in response to receiving the TC-SR with the NACK for the one or more missing RLC PDUs.

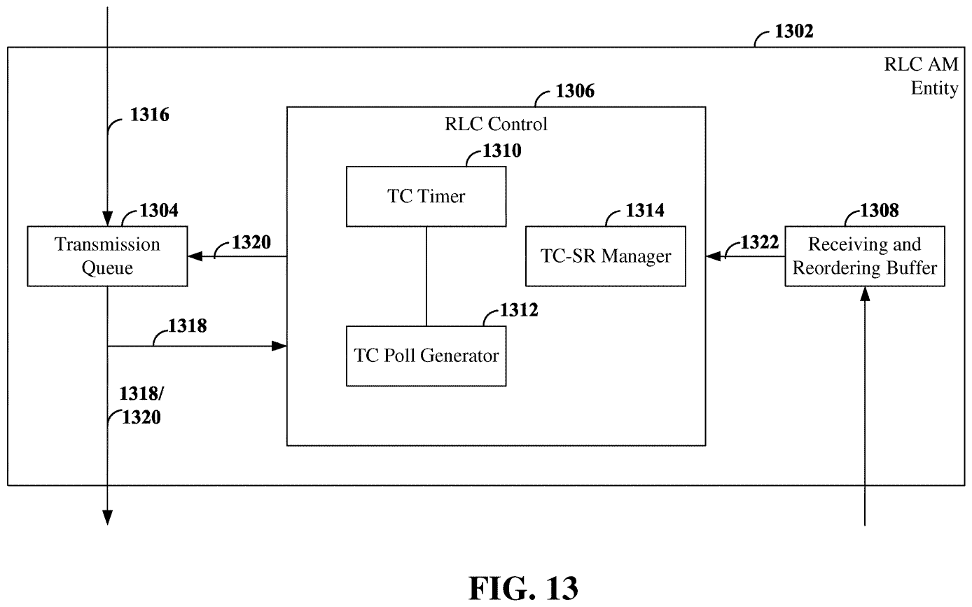

FIG. 13 is a diagram illustrating another example of an RLC-AM entity according to some aspects. In some examples, the RLC-AM entity 1302 can correspond to the RLC-AM entity 600 shown in FIG. 6 and/or the RLC-AM entity shown in FIG. 9. In the example shown in FIG. 13, the RLC-AM entity 1302 includes a transmission queue 1304, RLC control circuitry 1306, and a receiving and reordering buffer 1308. The RLC control circuitry 1306 can include a time-critical (TC) timer 1310, a TC poll generator 1312, and a TC-SR manager 1314.

Incoming RLC SDUs 1316 (e.g., from an upper layer, such as the PDCP sublayer) are received into the transmission queue 1304 for concatenation or segmentation into RLC PDUs 1318. The RLC control circuitry 1306 may inspect the RLC PDUs 1318 to determine whether one or more of the RLC SDUs are associated with low-latency traffic (e.g., XR/VR traffic). For each RLC PDU carrying low-latency traffic, the RLC control circuitry 1306 can initiate a respective TC timer 1310. The duration of the TC timer 1310 may be configured by the network or set in accordance with one or more standards or specifications.

Upon expiration of the TC timer 1310, the TC poll generator 1312 is configured to generate a time-critical (TC) poll 1320 and to provide the TC poll to the transmission queue 1304 for transmission to the receiver in an RLC PDU. The TC poll can include a TC indication that triggers the receiver to send a TC-SR. The TC indication thus distinguishes the TC poll from a normal poll request that triggers a normal (regular) status report (SR).

The receiving and reordering buffer 1308 may be configured to receive a TC-SR 1322 from the receiver in response to the TC poll and to provide the TC-SR 1322 to the RLC control circuitry 1306. The TC-SR 1322 may include, for example, an ACK or NACK for the low-latency RLC PDU. If the TC-SR 1322 includes a NACK, the RLC control circuitry 1306 can send an ARQ retransmission of the low-latency RLC PDU. In some examples, the corresponding RLC-AM at the receiver may include, for example, the TC-SR generator 914 shown in FIG. 9 to generate the TC-SR 1322 in response to receiving the TC poll 1320. In addition, the TC-SR may be sent with the prioritization at the RLC and MAC sublayers discussed herein. By triggering a TC-SR earlier than a normal SR, the ARQ retransmission latency can be reduced.

In some examples, the TC poll 1320 may be prioritized similar to the TC-SR. For example, at the RLC sublayer, the TC poll 1320 may be placed at the head of the transmission queue 1304 to ensure that the TC-SR 1110 is sent before any other types of RLC control PDUs and RLC data PDUs. In addition, at the MAC sublayer, the TC poll 1320 may be sent with a higher priority than the logical channel associated with the RLC entity 1302. The TC poll may further be sent irrespective of the value of the LCP leaky budget limit Bj for the logical channel. For example, the TC poll 1320 may be sent in violation of a LCP leaky bucket limit of the logical channel of the RLC entity 1302.

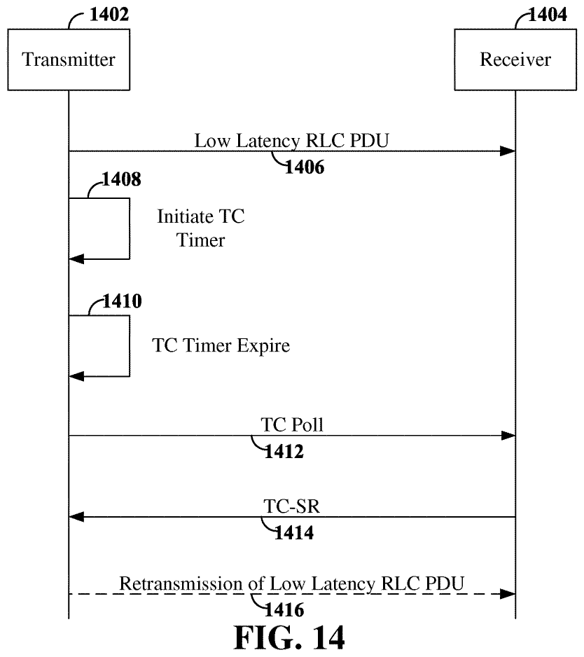

FIG. 14 is a signaling diagram illustrating another example of reduced latency ARQ retransmission between a transmitter 1402 (e.g., transmitting node) and a receiver 1404 (e.g., receiving node) using a time-critical status report according to some aspects. Each of the transmitter 1402 and the receiver 1204 may correspond, for example, to one of a user equipment (UE) or a network entity. For example, the transmitter 1202 may be a network entity and the receiver 1204 may be a UE, or vice-versa. The UE may correspond to any of the UEs or other wireless communication devices shown in any of FIGS. 1 and/or 2. The network entity may correspond to any of the base stations or other network entities shown in FIGS. 1 and/or 2. For example, the network entity may correspond to an aggregated base station, an RU, a DU, a CU, a TRP, an IAB node, or other network device.

At 1406, the transmitter 1402 may provide an RLC PDU to the receiver 1404. In some examples, the RLC PDU may carry low-latency traffic, such as XR/VR traffic. At 1408, the transmitter 1402 may initiate a TC timer in response to transmission of the RLC PDU. The TC timer duration may be configured by the network or one or more standards or specifications.

At 1410, the transmitter 1402 may determine that the TC timer has expired, and at 1412, provide a TC poll to the receiver 1404 in response to expiration of the TC timer. The TC poll may include a TC indication that indicates the poll is for a time-critical (low-latency) RLC PDU. At 1414, the receiver 1404 may generate and transmit a TC-SR to the transmitter 1402 in response to the TC poll. The TC-SR includes an ACK or NACK for the low-latency RLC PDU. At 1416, if the TC-SR includes a NACK, the transmitter 1402 can provide an ARQ retransmission of the low-latency RLC PDU to the receiver 1404.

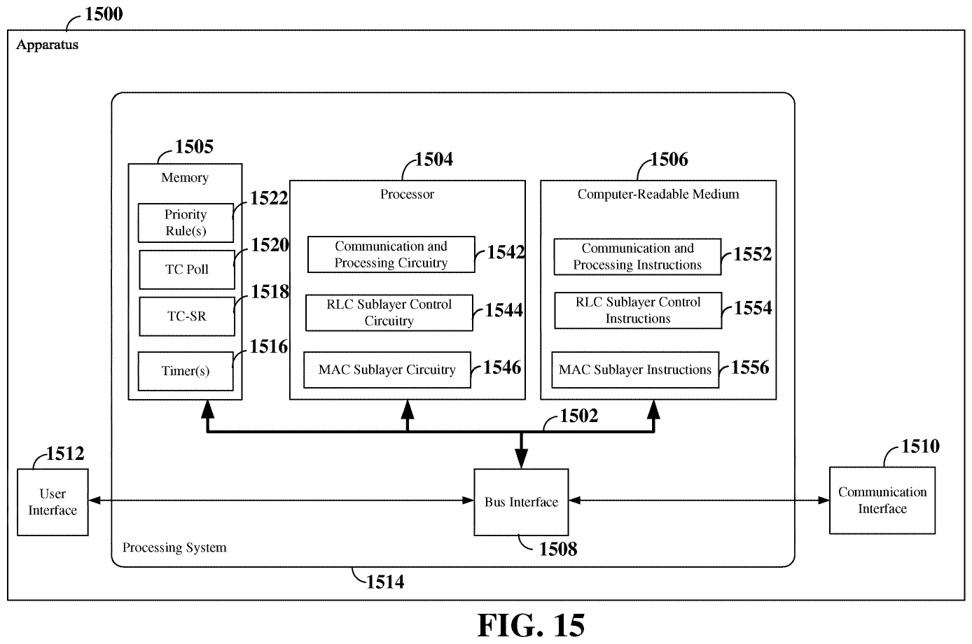

FIG. 15 is a block diagram illustrating an example of a hardware implementation of an apparatus 1500 employing a processing system 1514 according to some aspects. For example, the apparatus 1500 may correspond to any of the UEs shown and described above in reference to FIGS. 1 and/or 2 and/or to any of the base stations or other network entities shown in FIGS. 1 and/or 2. For example, the network entity may correspond to an aggregated base station, an RU, a DU, a CU, a TRP, an IAB node, or other network device.

In accordance with various aspects of the disclosure, an element, or any portion of an element, or any combination of elements may be implemented with a processing system 1514 that includes one or more processors, such as processor 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1500 may be configured to perform any one or more of the functions described herein. That is, the processor 1504, as utilized in the apparatus 1500, may be used to implement any one or more of the methods or processes described and illustrated herein.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits, including one or more processors (represented generally by the processor 1504), one or more memories (represented generally by the memory 1505), and one or more computer-readable media (represented generally by the computer-readable medium 1506). In some examples, the computer-readable media 1506 may be included within or part of one or more of the memories 1505. The bus 1502 may also link various other circuits such as timing sources, peripherals, voltage regulators, and power management circuits, which are well known in the art, and therefore, are not described any further.

A bus interface 1508 provides an interface between the bus 1502 and one or more communication interfaces 1510 (e.g., one or more transceivers, one or more antenna ports, and/or one or more network interfaces). The communication interface 1510 provides a means for communicating with various other apparatus over a transmission medium (e.g., air interface or backhaul network). The bus interface 1508 further provides an interface between the bus 1502 and a user interface 1512 (e.g., keypad, display, touch screen, speaker, microphone, control features, etc.). Of course, such a user interface 1512 may be omitted in some examples.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. In some examples, the computer-readable medium 1506 may be part of the memory 1505. Those skilled in the art will recognize how best to implement the described functionality presented throughout this disclosure depending on the particular application and the overall design constraints imposed on the overall system. In some examples, the computer-readable medium 1506 may be implemented on an article of manufacture, which may further include one or more other elements or circuits, such as the processor 1504 and/or memory 1505.

The computer-readable medium 1506 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1504, may be responsible for managing the bus 1502 and general processing, including the execution of the software (e.g., instructions or computer-executable code) stored on the computer-readable medium 1506. The software, when executed by the processor 1504, causes the processing system 1514 to perform the various processes and functions described herein for any particular apparatus. The computer-readable medium 1506 and/or the memory 1505 may also be used for storing data that may be manipulated by the processor 1504 when executing software. For example, the memory 1505 may store one or more timers 1516, one or more time-critical status reports (TC-SRs) 1518, one or more TC polls 1520, and/or one or more priority rules 1522.

In some aspects of the disclosure, the processor 1504 may include circuitry configured for various functions. For example, the processor 1504 may include communication and processing circuitry 1542 configured to communicate with one or more wireless devices, such as one or more UEs and/or one or more network entities. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1542 may include one or more transmit/receive chains.

In some implementations where the communication involves receiving information, the communication and processing circuitry 1542 may obtain information from a component of the apparatus 1500 (e.g., from the communication interface 1510 that receives the information via radio frequency signaling or some other type of signaling suitable for the applicable communication medium), process (e.g., decode) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 1542 may obtain information (e.g., from another component of the processor 1504, the memory 1505, or the bus interface 1508), process (e.g., modulate, encode, etc.) the information, and output the processed information. For example, the communication and processing circuitry 1542 may output the information to the communication interface 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc.

In some examples, the communication and processing circuitry 1542 may be configured to receive and process downlink beamformed signals at a mmWave frequency or a sub-6 GHz frequency via the communication interface 1510 (e.g., via a transceiver and antenna port(s) using a phase-shifter). In addition, the communication and processing circuitry 1542 may be configured to generate and transmit uplink beamformed signals at a mmWave frequency or a sub-6 GHz frequency via the communication interface 1510.

In some examples, the communication and processing circuitry 1542 may be configured to communicate with a transmitting node (e.g., a UE and/or a network entity, such as an aggregated or disaggregated base station gNB, TRP(s), etc.) to obtain (e.g., receive) a plurality of received radio link control (RLC) protocol data units (PDUs) within a sequence of RLC PDUs from the transmitting node. Each of the RLC PDUs in the sequence of RLC PDUs includes a respective sequence number. The communication and processing circuitry 1542 may further be configured to provide (e.g., transmit) a time-critical status report (TC-SR) 1518 including a negative acknowledgement of at least one of one or more missing RLC PDUs within the sequence of RLC PDUs to the transmitting node. In some examples, the communication and processing circuitry 1542 may further be configured to obtain (e.g., receive) a retransmission of at least one of the one or more missing RLC PDUs based on the TC-SR.

The communication and processing circuitry 1542 may further be configured to provide (e.g., transmit) a radio link control (RLC) protocol data unit (PDU) associated with low-latency traffic to a receiving node. The communication and processing circuitry 1542 may further be configured to provide (e.g., transmit) a TC poll 1520 to the receiving node and obtain (e.g., receive) a TC-SR 1518 from the receiving node that includes acknowledgement information associated with the RLC PDU based on the TC poll. The communication and processing circuitry 1542 may further be configured to execute communication and processing software 1552 stored on the computer-readable medium 1506 to implement one or more functions described herein.

The processor 1504 may further include RLC sublayer control circuitry 1544, configured to initiate a timer (e.g., one of the timers 1516) in response to identifying a gap between the respective sequence numbers of the plurality of received RLC PDUs. Here, the gap includes one or more missing RLC PDUs within the sequence of RLC PDUs. The RLC sublayer control circuitry 1544 may further be configured to instruct the communication and processing circuitry 1542 to provide the TC-SR 1518 including the negative acknowledgement of at least one of the one or more missing RLC PDUs within the sequence of RLC PDUs based on at least a value of the timer 1516.

In some examples, the RLC sublayer control circuitry 1544 is configured to initiate a single timer 1516 for all of the one or more missing RLC PDUs within the gap and to provide a single TC-SR 1518 for all of the one or more missing RLC PDUs within the gap based on at least the value of the single timer. In some examples, the RLC sublayer control circuitry 1544 is further configured to cancel the single timer 1516 upon obtaining an additional received RLC PDU of the one or more missing RLC PDUs, in which the additional received RLC PDU includes a lowest sequence number in the gap. In this example, the RLC sublayer control circuitry 1544 can be further configured to increment the lowest sequence number in the gap by one to produce a new lowest sequence number and initiate a new timer in response to a continued missing RLC PDU of the one or more missing RLC PDUs within the gap including the new lowest sequence number.

In some examples, the RLC sublayer control circuitry 1544 is configured to initiate a respective timer for each of the one or more missing RLC PDUs within the gap and to provide a respective TC-SR for each of the one or more missing RLC PDUs within the gap based on at least a respective value of each of the respective timers. In this example, the RLC sublayer control circuitry can further be configured to cancel the respective timer for each of the one or more missing RLC PDUs that are received prior to transmission of the respective TC-SR.

In some examples, the RLC sublayer control circuitry 1544 can be configured to provide the TC-SR 1518 upon expiration of the timer 1516. In some examples, the RLC sublayer control circuitry 1544 can be configured to provide the TC-SR 1518 in response to the value of the timer falling below a threshold. In some examples, the RLC sublayer control circuitry 1544 can be configured to provide the TC-SR 1518 prior to other RLC PDUs in a transmission queue (e.g., which may be within the memory 1505). In some examples, the RLC sublayer control circuitry 1544 may be configured to provide the TC-SR 1518 prior to expiration of a status report prohibit timer (e.g., one of the timers 1516) initiated upon transmission of an immediately prior status report. In some examples, the RLC sublayer control circuitry 1544 is configured to provide the TC-SR upon expiration of a TC-SR prohibit timer initiated upon transmission of an immediately prior status report. In this example, the TC-SR prohibit timer has a shorter duration than a regular status report prohibit timer initiated upon transmission of the immediately prior status report.

The RLC sublayer control circuitry 1544 is further configured to initiate a time-critical (TC) timer (e.g., one of the timers 1516) in response to transmission of an RLC PDU to a receiving node and to instruct the communication and processing circuitry 1542 to provide the TC poll 1520 to the receiving node in response to expiration of the TC timer. In some examples, the TC poll includes a TC indication that triggers the receiving node to provide a TC-SR 1518. The RLC sublayer control circuitry 1544 may further be configured to execute RLC sublayer control instructions (software) 1554 stored on the computer-readable medium 1506 to implement one or more functions described herein.

The processor 1504 may further include MAC sublayer control circuitry 1546, configured to assign the TC-SR 1518 a first priority at the MAC layer (e.g., MAC sublayer) that is higher than a second priority of a logical channel of an RLC entity associated with the sequence of RLC PDUs. For example, the MAC sublayer control circuitry 1546 may utilize one or more priority rules 1522 to assign the first priority to the TC-SR 1518. In some examples, the first priority is a highest configurable priority for a data logical channel. In some examples, the second priority is a default priority of the logical channel and the first priority is a higher configured priority for the logical channel than the default priority. In some examples, the first priority is configured by a network for all logical channels. In some examples, the MAC sublayer control circuitry 1546 is further configured to provide the TC-SR in violation of a logical channel prioritization (LCP) leaky bucket limit of a logical channel of an RLC entity associated with the sequence of RLC PDUs.

The MAC sublayer control circuitry 1546 is further configured to assign the TC poll 1520 a first priority at the MAC layer (e.g., MAC sublayer) that is higher than a second priority of a logical channel of an RLC entity associated with the sequence of RLC PDUs. For example, the MAC sublayer control circuitry 1546 may utilize one or more priority rules 1522 to assign the first priority to the TC poll 1520. In some examples, the first priority is a highest configurable priority for a data logical channel. In some examples, the second priority is a default priority of the logical channel and the first priority is a higher configured priority for the logical channel than the default priority. In some examples, the first priority is configured by a network for all logical channels. In some examples, the MAC sublayer control circuitry 1546 is further configured to provide the TC poll in violation of a logical channel prioritization (LCP) leaky bucket limit of a logical channel of an RLC entity associated with the sequence of RLC PDUs. The MAC sublayer control circuitry 1546 may further be configured to execute MAC sublayer control instructions (software) 1556 stored on the computer-readable medium 1506 to implement one or more functions described herein.

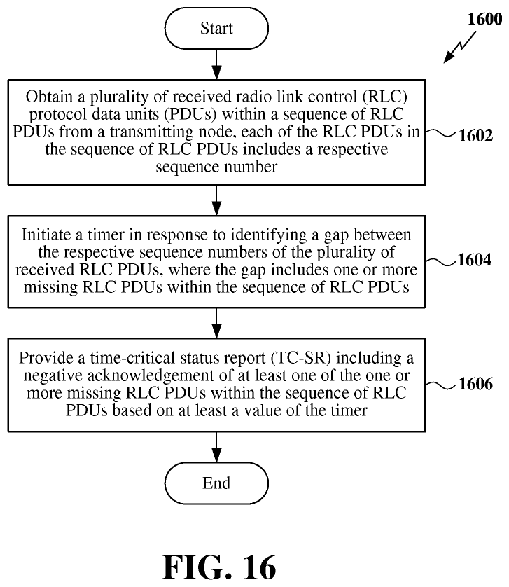

FIG. 16 is a flow chart illustrating an exemplary process 1600 for timely radio link control (RLC) status reports (SRs) according to some aspects. As described below, some or all illustrated features may be omitted in a particular implementation within the scope of the present disclosure, and some illustrated features may not be required for implementation of all embodiments. In some examples, the process 1600 may be carried out by the apparatus 1500 illustrated in FIG. 15. In some examples, the process 1600 may be carried out by any suitable apparatus or means for carrying out the functions or algorithm described below.

At block 1602, the apparatus (e.g., a receiving node) may obtain a plurality of received radio link control (RLC) protocol data units (PDUs) within a sequence of RLC PDUs from a transmitting node, where each of the RLC PDUs in the sequence of RLC PDUs includes a respective sequence number. For example, the communication and processing circuitry 1542 and communication interface 1510 shown and described above in connection with FIG. 15, may provide a means to obtain the plurality of RLC PDUs.

At block 1604, the apparatus may initiate a timer in response to identifying a gap between the respective sequence numbers of the plurality of received RLC PDUs, where the gap includes one or more missing RLC PDUs within the sequence of RLC PDUs. For example, the RLC sublayer control circuitry 1544, shown and described above in connection with FIG. 15, may provide a means to initiate the timer.

At block 1606, the apparatus may provide a time-critical status report (TC-SR) including a negative acknowledgement of at least one of the one or more missing RLC PDUs within the sequence of RLC PDUs based on at least a value of the timer. In some examples, the apparatus may further obtain a retransmission of at least one of the one or more missing RLC PDUs based on the TC-SR. For example, the RLC sublayer control circuitry 1544, together with the MAC sublayer control circuitry 1546, communication and processing circuitry 1542 and communication interface 1510, shown and described above in connection with FIG. 15, may provide a means to provide the TC-SR.

In some examples, the apparatus can initiate a single timer for all of the one or more missing RLC PDUs within the gap. The apparatus can further provide a single TC-SR for all of the one or more missing RLC PDUs within the gap based on at least the value of the single timer. In some examples, the apparatus can further cancel the single timer upon obtaining an additional received RLC PDU of the one or more missing RLC PDUs, where the additional received RLC PDU includes a lowest sequence number in the gap. The apparatus can then increment the lowest sequence number in the gap by one to produce a new lowest sequence number and initiate a new timer in response to a continued missing RLC PDU of the one or more missing RLC PDUs within the gap including the new lowest sequence number.

In some examples, the apparatus can initiate a respective timer for each of the one or more missing RLC PDUs within the gap. The apparatus can further provide a respective TC-SR for each of the one or more missing RLC PDUs within the gap based on at least a respective value of each of the respective timers. In some examples, the apparatus can further cancel the respective timer for each of the one or more missing RLC PDUs that are received prior to transmission of the respective TC-SR.

In some examples, the apparatus can provide the TC-SR upon expiration of the timer. In some examples, the apparatus can provide the TC-SR in response to the value of the timer falling below a threshold. In some examples, the apparatus can provide the TC-SR prior to other RLC PDUs in a transmission queue. In some examples, the apparatus can provide the TC-SR prior to expiration of a status report prohibit timer initiated upon transmission of an immediately prior status report. In some examples, the apparatus can provide the TC-SR upon expiration of a TC-SR prohibit timer initiated upon transmission of an immediately prior status report, wherein the TC-SR prohibit timer comprises a shorter duration than a regular status report prohibit timer initiated upon transmission of the immediately prior status report. In some examples, the apparatus can further provide the TC-SR in violation of a logical channel prioritization (LCP) leaky bucket limit of a logical channel of an RLC entity associated with the sequence of RLC PDUs.

In some examples, the TC-SR includes a first priority at a medium access control (MAC) layer that is higher than a second priority of a logical channel of an RLC entity associated with the sequence of RLC PDUs. In some examples, the first priority is a highest configurable priority for a data logical channel. In some examples, the second priority is a default priority of the logical channel and the first priority is a higher configured priority for the logical channel than the default priority. In some examples, the first priority is configured by a network for all logical channels.

In one configuration, the apparatus includes means for obtaining a plurality of received radio link control (RLC) protocol data units (PDUs) within a sequence of RLC PDUs from a transmitting node, wherein each of the RLC PDUs in the sequence of RLC PDUs comprises a respective sequence number, means for initiating a timer in response to identifying a gap between the respective sequence numbers of the plurality of received RLC PDUs, wherein the gap comprises one or more missing RLC PDUs within the sequence of RLC PDUs, and means for providing a time-critical status report (TC-SR) comprising a negative acknowledgement of at least one of the one or more missing RLC PDUs within the sequence of RLC PDUs based on at least a value of the timer. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, 5, 6, 9, 10A, 10B, 11, 13, and/or 15, and utilizing, for example, the processes and/or algorithms described herein in relation to FIGS. 12, 14, and 16.

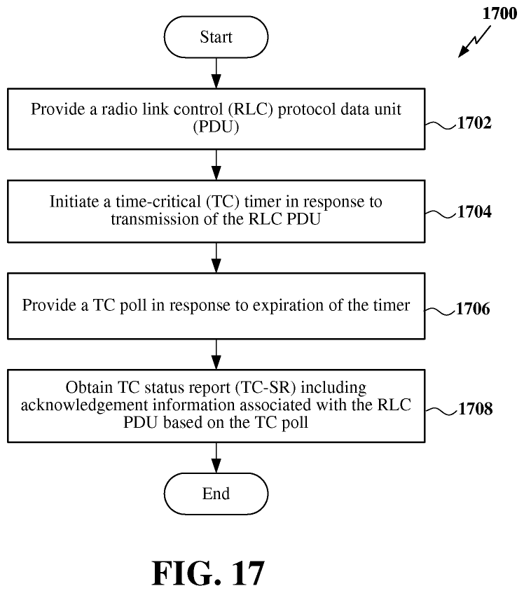

FIG. 17 is a flow chart illustrating another exemplary process 1700 for timely radio link control (RLC) status reports (SRs) according to some aspects. As described below, some or all illustrated features may be omitted in a particular implementation within the scope of the present disclosure, and some illustrated features may not be required for implementation of all embodiments. In some examples, the process 1700 may be carried out by the apparatus 1500 illustrated in FIG. 15. In some examples, the process 1700 may be carried out by any suitable apparatus or means for carrying out the functions or algorithm described below.

At block 1702, the apparatus may provide a radio link control (RLC) protocol data unit (PDU). For example, the communication and processing circuitry 1542 and communication interface 1510 shown and described above in connection with FIG. 15, may provide a means to provide the RLC PDU.

At block 1704, the apparatus may initiate a time-critical (TC) timer in response to transmission of the RLC PDU. For example, the RLC sublayer control circuitry 1544, shown and described above in connection with FIG. 15, may provide a means to initiate the TC timer.

At block 1706, the apparatus may provide a TC poll in response to expiration of the TC timer. For example, the RLC sublayer control circuitry 1544, together with the MAC sublayer control circuitry 1546, communication and processing circuitry 1542, and communication interface 1510, shown and described above in connection with FIG. 15, may provide a means to provide the TC poll.

In some examples, the TC poll includes a TC indication that triggers the TC-SR. In some examples, the TC poll includes a first priority at a medium access control (MAC) layer that is higher than a second priority of a logical channel of an RLC entity associated with the RLC PDU. In some examples, the first priority has a highest configurable priority for a data logical channel. In some examples, the second priority is a default priority of the logical channel and the first priority is a higher configured priority for the logical channel than the default priority. In some examples, the first priority is configured by a network for all logical channels. In some examples, the apparatus can further provide the TC poll in violation of a logical channel prioritization (LCP) leaky bucket limit of a logical channel of an RLC entity associated with the RLC PDU.

At block 1708, the apparatus may obtain a TC status report (TC-SR) comprising acknowledgement information associated with the RLC PDU based on the TC poll. For example, the communication and processing circuitry 1542 and communication interface 1510 shown and described above in connection with FIG. 15 may provide a means to obtain the TC-SR.

In one configuration, the UE includes means for providing a radio link control (RLC) protocol data unit (PDU), means for initiating a time-critical (TC) timer in response to transmission of the RLC PDU, means for providing a TC poll in response to expiration of the TC timer, and means for obtaining a TC status report (TC-SR) comprising acknowledgement information associated with the RLC PDU based on the TC poll. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, 5, 6, 9, 10A, 10B, 11, 13, and/or 15, and utilizing, for example, the processes and/or algorithms described herein in relation to FIGS. 12, 14, and 17.

The following provides an overview of aspects of the present disclosure:

Aspect 1: A method operable at a receiving node, the method comprising: obtaining a plurality of received radio link control (RLC) protocol data units (PDUs) within a sequence of RLC PDUs from a transmitting node, wherein each of the RLC PDUs in the sequence of RLC PDUs comprises a respective sequence number; initiating a timer in response to identifying a gap between the respective sequence numbers of the plurality of received RLC PDUs, wherein the gap comprises one or more missing RLC PDUs within the sequence of RLC PDUs; and providing a time-critical status report (TC-SR) comprising a negative acknowledgement of at least one of the one or more missing RLC PDUs within the sequence of RLC PDUs based on at least a value of the timer.

Aspect 2: The method of aspect 1, further comprising: initiating a single timer for all of the one or more missing RLC PDUs within the gap; and providing a single TC-SR for all of the one or more missing RLC PDUs within the gap based on at least the value of the single timer.

Aspect 3: The method of aspect 2, further comprising: canceling the single timer upon obtaining an additional received RLC PDU of the one or more missing RLC PDUs, wherein the additional received RLC PDU comprises a lowest sequence number in the gap; incrementing the lowest sequence number in the gap by one to produce a new lowest sequence number; and initiating a new timer in response to a continued missing RLC PDU of the one or more missing RLC PDUs within the gap comprising the new lowest sequence number.

Aspect 4: The method of aspect 1, further comprising: initiating a respective timer for each of the one or more missing RLC PDUs within the gap; and providing a respective TC-SR for each of the one or more missing RLC PDUs within the gap based on at least a respective value of each of the respective timers.

Aspect 5: The method of any of aspect 4, further comprising: canceling the respective timer for each of the one or more missing RLC PDUs that are received prior to transmission of the respective TC-SR.

Aspect 6: The method of any of aspects 1 through 5, wherein the providing the TC-SR further comprises: providing the TC-SR upon expiration of the timer.

Aspect 7: The method of any of aspects 1 through 5, wherein the providing the TC-SR further comprises: providing the TC-SR in response to the value of the timer falling below a threshold.

Aspect 8: The method of any of aspects 1 through 7, wherein the providing the TC-SR further comprises: providing the TC-SR prior to other RLC PDUs in a transmission queue.

Aspect 9: The method of any of aspects 1 through 8, wherein the providing the TC-SR further comprises: providing the TC-SR prior to expiration of a status report prohibit timer initiated upon transmission of an immediately prior status report.

Aspect 10: The method of any of aspects 1 through 8, wherein the providing the TC-SR further comprises: providing the TC-SR upon expiration of a TC-SR prohibit timer initiated upon transmission of an immediately prior status report, wherein the TC-SR prohibit timer comprises a shorter duration than a regular status report prohibit timer initiated upon transmission of the immediately prior status report.

Aspect 11: The method of any of aspects 1 through 10, wherein the TC-SR comprises a first priority at a medium access control (MAC) layer that is higher than a second priority of a logical channel of an RLC entity associated with the sequence of RLC PDUs.

Aspect 12: The method of aspect 11, wherein the first priority comprises a highest configurable priority for a data logical channel.

Aspect 13: The method of aspect 11, wherein the second priority is a default priority of the logical channel and the first priority is a higher configured priority for the logical channel than the default priority.

Aspect 14: The method of aspect 11, wherein the first priority is configured by a network for all logical channels.

Aspect 15: The method of any of aspects 1 through 14, further comprising: providing a capability of the UE to the network entity, wherein the capability indicates a number of the plurality of resources.

Aspect 16: The method of any of aspects 1 through 15, wherein the providing the TC-SR further comprises: providing the TC-SR in violation of a logical channel prioritization (LCP) leaky bucket limit of a logical channel of an RLC entity associated with the sequence of RLC PDUs.

Aspect 17: The method of any of aspects 1 through 16, further comprising: obtaining a retransmission of at least one of the one or more missing RLC PDUs based on the TC-SR.

Aspect 18: An apparatus comprising one or more memories and one or more processors coupled to the one or more memories, wherein the one or more processors are configured to cause the apparatus to perform a method of any of aspects 1 through 17.

Aspect 19: An apparatus comprising means for performing a method of any of aspects 1 through 17.

Aspect 20: A non-transitory computer-readable medium having stored therein instructions executable by one or more processors of an apparatus to cause the apparatus to perform a method of any of aspects 1 through 17.

Aspect 21: A method operable at a transmitting node, the method comprising: providing a radio link control (RLC) protocol data unit (PDU); initiating a time-critical (TC) timer in response to transmission of the RLC PDU; providing a TC poll in response to expiration of the TC timer; and obtaining a TC status report (TC-SR) comprising acknowledgement information associated with the RLC PDU based on the TC poll.

Aspect 22: The method of aspect 21, wherein the TC poll comprises a TC indication that triggers the TC-SR.

Aspect 23: The method of aspect 21 or 22, wherein the TC poll comprises a first priority at a medium access control (MAC) layer that is higher than a second priority of a logical channel of an RLC entity associated with the RLC PDU.

Aspect 24: The method of aspect 23, wherein the first priority comprises a highest configurable priority for a data logical channel.

Aspect 25: The method of aspect 23, wherein the second priority is a default priority of the logical channel and the first priority is a higher configured priority for the logical channel than the default priority.

Aspect 26: The method of aspect 23, wherein the first priority is configured by a network for all logical channels.

Aspect 27: The method of any of aspects 21 through 26, wherein the providing the TC poll further comprises: providing the TC poll in violation of a logical channel prioritization (LCP) leaky bucket limit of a logical channel of an RLC entity associated with the RLC PDU.

Aspect 28: An apparatus comprising one or more memories and one or more processors coupled to the one or more memories, wherein the one or more processors are configured to cause the apparatus to perform a method of any of aspects 21 through 27.

Aspect 29: An apparatus comprising means for performing a method of any of aspects 21 through 27.

Aspect 30: A non-transitory computer-readable medium having stored therein instructions executable by one or more processors of an apparatus to cause the apparatus to perform a method of any of aspects 21 through 27.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP 2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 5, 6, and/or 8-15 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus, comprising:
one or more memories; and
one or more processors coupled to the one or more memories, wherein the one or processors are configured to cause the apparatus to:
obtain a plurality of received radio link control (RLC) protocol data units (PDUs) within a sequence of RLC PDUs from a transmitting node, wherein each of the RLC PDUs in the sequence of RLC PDUs comprises a respective sequence number;
initiate a timer in response to identifying a gap between the respective sequence numbers of the plurality of received RLC PDUs, wherein the gap comprises one or more missing RLC PDUs within the sequence of RLC PDUs; and
provide a time-critical status report (TC-SR) comprising a negative acknowledgement of at least one of the one or more missing RLC PDUs within the sequence of RLC PDUs based on at least a value of the timer.

2. The apparatus of claim 1, wherein the one or more processors are further configured to cause the apparatus to:
initiate a single timer for all of the one or more missing RLC PDUs within the gap; and
provide a single TC-SR for all of the one or more missing RLC PDUs within the gap based on at least the value of the single timer.

3. The apparatus of claim 2, wherein the one or more processors are further configured to cause the apparatus to:
cancel the single timer upon obtaining an additional received RLC PDU of the one or more missing RLC PDUs, wherein the additional received RLC PDU comprises a lowest sequence number in the gap;
increment the lowest sequence number in the gap by one to produce a new lowest sequence number; and
initiate a new timer in response to a continued missing RLC PDU of the one or more missing RLC PDUs within the gap comprising the new lowest sequence number.

4. The apparatus of claim 1, wherein the one or more processors are further configured to cause the apparatus to:
initiate a respective timer for each of the one or more missing RLC PDUs within the gap; and
provide a respective TC-SR for each of the one or more missing RLC PDUs within the gap based on at least a respective value of each of the respective timers.

5. The apparatus of claim 4, wherein the one or more processors are further configured to cause the apparatus to:
cancel the respective timer for each of the one or more missing RLC PDUs that are received prior to transmission of the respective TC-SR.

6. The apparatus of claim 1, wherein the one or more processors are further configured to cause the apparatus to:
provide the TC-SR upon expiration of the timer.

7. The apparatus of claim 1, wherein the one or more processors are further configured to cause the apparatus to:
provide the TC-SR in response to the value of the timer falling below a threshold.

8. The apparatus of claim 1, wherein the one or more processors are further configured to cause the apparatus to:
provide the TC-SR prior to other RLC PDUs in a transmission queue.

9. The apparatus of claim 1, wherein the one or more processors are further configured to cause the apparatus to:
provide the TC-SR prior to expiration of a status report prohibit timer initiated upon transmission of an immediately prior status report.

10. The apparatus of claim 1, wherein the one or more processors are further configured to cause the apparatus to:
provide the TC-SR upon expiration of a TC-SR prohibit timer initiated upon transmission of an immediately prior status report, wherein the TC-SR prohibit timer comprises a shorter duration than a regular status report prohibit timer initiated upon transmission of the immediately prior status report.

11. The apparatus of claim 1, wherein the TC-SR comprises a first priority at a medium access control (MAC) layer that is higher than a second priority of a logical channel of an RLC entity associated with the sequence of RLC PDUs.

12. The apparatus of claim 11, wherein the first priority comprises a highest configurable priority for a data logical channel.

13. The apparatus of claim 11, wherein the second priority is a default priority of the logical channel and the first priority is a higher configured priority for the logical channel than the default priority.

14. The apparatus of claim 11, wherein the first priority is configured by a network for all logical channels.

15. The apparatus of claim 1, wherein the one or more processors are further configured to cause the apparatus to:
provide the TC-SR in violation of a logical channel prioritization (LCP) leaky bucket limit of a logical channel of an RLC entity associated with the sequence of RLC PDUs.

16. The apparatus of claim 1, wherein the one or more processors are further configured to cause the apparatus to:
obtain a retransmission of at least one of the one or more missing RLC PDUs based on the TC-SR.

17. A method operable at a receiving node, the method comprising:
obtaining a plurality of received radio link control (RLC) protocol data units (PDUs) within a sequence of RLC PDUs from a transmitting node, wherein each of the RLC PDUs in the sequence of RLC PDUs comprises a respective sequence number;
initiating a timer in response to identifying a gap between the respective sequence numbers of the plurality of received RLC PDUs, wherein the gap comprises one or more missing RLC PDUs within the sequence of RLC PDUs; and
providing a time-critical status report (TC-SR) comprising a negative acknowledgement of at least one of the one or more missing RLC PDUs within the sequence of RLC PDUs based on at least a value of the timer.

18. The method of claim 17, further comprising:
initiating a single timer for all of the one or more missing RLC PDUs within the gap;
providing a single TC-SR for all of the one or more missing RLC PDUs within the gap based on at least the value of the single timer;
canceling the single timer upon obtaining an additional received RLC PDU of the one or more missing RLC PDUs, wherein the additional received RLC PDU comprises a lowest sequence number in the gap;
incrementing the lowest sequence number in the gap by one to produce a new lowest sequence number; and
initiating a new timer in response to a continued missing RLC PDU of the one or more missing RLC PDUs within the gap comprising the new lowest sequence number.

19. The method of claim 17, further comprising:
initiating a respective timer for each of the one or more missing RLC PDUs within the gap;
providing a respective TC-SR for each of the one or more missing RLC PDUs within the gap based on at least a respective value of each of the respective timers; and
canceling the respective timer for each of the one or more missing RLC PDUs that are received prior to transmission of the respective TC-SR.

20. An apparatus, comprising:
means for obtaining a plurality of received radio link control (RLC) protocol data units (PDUs) within a sequence of RLC PDUs from a transmitting node, wherein each of the RLC PDUs in the sequence of RLC PDUs comprises a respective sequence number;
means for initiating a timer in response to identifying a gap between the respective sequence numbers of the plurality of received RLC PDUs, wherein the gap comprises one or more missing RLC PDUs within the sequence of RLC PDUs; and
means for providing a time-critical status report (TC-SR) comprising a negative acknowledgement of at least one of the one or more missing RLC PDUs within the sequence of RLC PDUs based on at least a value of the timer.
